(19) United States
(12) Patent Application Publication
(10) Pub. No.: US 2026/0107076 A1
(43) Pub. Date: Apr. 16, 2026

(54) IMAGING DEVICE

(71) Applicant: SONY SEMICONDUCTOR SOLUTIONS CORPORATION, KANAGAWA (JP)

(72) Inventor: Mamoru SATO, KANAGAWA (JP)

(21) Appl. No.: 19/104,348

(22) PCT Filed: Jun. 30, 2023
(86) PCT No.: PCT/JP2023/024429

§ 371 Date: Feb. 17, 2025

(30) Foreign Application Priority Data
Aug. 25, 2022 (JP) 2022-134127

(51) Int. Cl. H04N 25/78; H04N 25/67; H04N 25/771

(52) U.S. Cl. CPC H04N 25/78; H04N 25/771; H04N 25/67

(57) ABSTRACT

It is possible to prevent a black level output based on incidence of high brightness light.

An imaging device includes: a signal line whose potential changes based on a charge stored according to a current flowing at a time of readout of a signal from a pixel; a signal line reset transistor that resets the potential of the signal line; a signal line reset level generation unit that generates a reset level of the potential of the signal line; a signal line clip transistor that clips the potential of the signal line; and a signal line clip voltage setting unit that sets a signal line clip voltage used to generate a clip level of the potential of the signal line. The signal line reset level generation unit may be a diode connection transistor.

### TECHNICAL FIELD

The present technology relates to an imaging device. More specifically, the present technology relates to an imaging device that can prevent a black level output based on incidence of high brightness light.

### BACKGROUND ART

There is known a capacitive load readout method that uses a capacitance for a load of a source follower at a time of readout of a signal from a pixel. As such a capacitive load readout method, there has been proposed, for example, an imaging device that causes a constant current to flow to an output line by a constant current source after a voltage of the output line is reset by a reset unit, and connects a source of an amplifier transistor to the output line (see, for example, PTL 1).

### CITATION LIST

### Patent Literature

[PTL 1]

JP 2021-40270 A

### SUMMARY

### Technical Problem

However, according to the above-described conventional technology, when high brightness light such as sunlight is incident, a charge overflows from a photodiode to a floating diffusion. Hence, a P phase level (also referred to as a reset level) lowers and there is no difference between the P phase level and a D phase level (also referred to as a signal level), and therefore a phenomenon (referred to as a sunspot phenomenon) occurs that a black level is output even though the P phase level is originally a white level.

With such a situation in view, an object of the present technology is to make it possible to prevent output of a black level based on incidence of high brightness light.

### Solution to Problem

The present technology has been made to solve the above-described problem, and a first aspect of the present technology is an imaging device that includes: a signal line whose potential changes based on a charge stored according to a current flowing at a time of readout of a signal from a pixel; a signal line reset transistor that resets the potential of the signal line; a signal line reset level generation unit that generates a reset level of the potential of the signal line; a signal line clip transistor that clips the potential of the signal line; and a signal line clip voltage setting unit that sets a signal line clip voltage used to generate a clip level of the potential of the signal line. Consequently, it is possible to provide an effect that the potential of the signal line is clipped without depending on an incident light amount.

Furthermore, according to the first aspect, the potential of the signal line may be a potential a parasitic capacitance of the signal line. Consequently, it is possible to provide an effect that it is possible to read out a capacitive load without adding a capacitive element to the signal line.

Furthermore, according to the first aspect, the pixel may include a photodiode, a transfer transistor that transfers a charge stored in the photodiode to a floating diffusion, a reset transistor that resets the floating diffusion, an amplifier transistor that outputs a signal corresponding to the potential of the floating diffusion, and a selection transistor that is connected between the amplifier transistor and the signal line. Consequently, it is possible to provide an effect that a source follower is formed with respect to a pixel at a time of readout of a signal from the pixel.

Furthermore, according to the first aspect, the signal line reset level generation unit may include a diode connection transistor. Consequently, it is possible to provide an effect that the potential of the signal line is increased according to a forward voltage of the diode connection transistor at a time of resetting of the signal line.

Furthermore, according to the first aspect, the imaging device may further include a driver that drives the signal line reset transistor. Consequently, it is possible to provide an effect that the signal line reset transistor is turned on/off.

Furthermore, according to the first aspect, the imaging device may further include a signal line clip selection transistor that is connected between the signal line and the signal line clip transistor. Consequently, it is possible to provide an effect that application of the clip level to the signal line is controlled.

Furthermore, according to the first aspect, the imaging device may further include: a first chip on which the pixel, the signal line clip transistor, and the signal line clip selection transistor have been formed, and a second chip on which the first chip has been stacked, and the signal line reset transistor, the signal line reset level generation unit, and the signal line clip voltage setting unit have been formed. Consequently, it is possible to provide an effect that variations of characteristics of the signal line clip transistor and the signal line clip selection transistor and characteristics of a pixel transistor are reduced.

Furthermore, according to the first aspect, a gate length and a gate width of the signal line clip transistor may be equal to a gate length and a gate width of an amplifier transistor of the pixel, and a gate length and a gate width of the signal line clip selection transistor may be equal to a gate length and a gate width of a selection transistor of the pixel. Consequently, it is possible to provide an effect that characteristics of the signal line clip transistor and characteristics of the amplifier transistor of the pixel become equal, and characteristics of the signal line clip selection transistor and characteristics of the selection transistor of the pixel become equal.

Furthermore, according to the first aspect, the signal line may be simultaneously driven by the signal line clip selection transistor and an amplifier transistor of the pixel. Consequently, it is possible to provide an effect that a driving force of the signal line increases.

Furthermore, according to the first aspect, the imaging device may further include a comparator that compares the potential of the signal line and a ramp signal. Consequently, it is possible to provide an effect that it is possible to detect a signal read out from the pixel based on the potential of the signal line.

Furthermore, according to the first aspect, the imaging device may further include a comparator that compares potentials of signal lines provided to different columns. Consequently, it is possible to provide an effect that an edge of a subject is detected based on readout of a capacitive load.

Furthermore, according to the first aspect, the imaging device may further include:
a first DC cut capacitor that is connected to a first input terminal of the comparator; a second DC cut capacitor that is connected to a second input terminal of the comparator; and an auto-zero control unit that respectively controls charges stored in the first DC cut capacitor and the second DC cut capacitor such that a first input and a second input of the comparator during an auto-zero period balance. Consequently, it is possible to provide an effect that fixed pattern noise is reduced.

Furthermore, according to the first aspect, the signal line clip selection transistor may be turned off after the auto-zero period. Consequently, it is possible to provide an effect that a non-inverting input and an inverting input of the comparator are adjusted to balance at a time when the signal line is clipped.

Furthermore, according to the first aspect, the signal line clip voltage may be lower than a reset level of the pixel. Consequently, it is possible to provide an effect that it is possible to read out the reset level of the pixel.

Furthermore, according to the first aspect, the imaging device may further include a constant current transistor that can be electrically connected to the signal line, and causes a constant current to flow based on a source follower formed between the constant current transistor and the pixel. Consequently, it is possible to provide an effect that it is possible to read out the constant current when the capacitive load is not read out.

Furthermore, according to the first aspect, the constant current transistor may be turned on when the constant current is read out using the constant current transistor, and the constant current transistor may be turned off when a capacitive load is read out using the signal line reset level generation unit. Consequently, it is possible to provide an effect that it is possible to switch between readout of the capacitive load and readout of the constant current.

Furthermore, according to the first aspect, the signal line clip voltage setting unit may generate a plurality of the clip levels. Consequently, it is possible to provide an effect that the clip level of the signal line is adjusted.

Furthermore, according to the first aspect, the signal line clip voltage setting unit may include a resistance ladder circuit, and a first selector that switches a divided voltage generated by the resistance ladder circuit. Consequently, it is possible to provide an effect that the clip level of the signal line is switched.

Furthermore, according to the first aspect, the signal line reset level generation unit may include a second selector that switches a divided voltage generated by the resistance ladder circuit. Consequently, it is possible to provide an effect that the reset level and the clip level of the signal line are individually switched.

Furthermore, according to the first aspect, the imaging device may further include a pixel array unit in which the pixels are disposed in a matrix in a row direction and a column direction, the signal line may be provided per column, and the signal line reset transistor and the signal line clip transistor may be provided to each signal line. Consequently, it is possible to provide an effect that the potential of the signal line is reset and clipped per signal line.

### BRIEF DESCRIPTION OF DRAWINGS

FIG. 1 is a block diagram illustrating a configuration example of a camera to which an imaging device according to a first embodiment is applied.

FIG. 2 is a block diagram illustrating a configuration example of a solid-state imaging device according to the first embodiment.

FIG. 3 is a block diagram illustrating a circuit configuration example of a pixel provided to the solid-state imaging device according to the first embodiment.

FIG. 4 is a cross-sectional view illustrating a configuration example of a pixel array unit provided to the solid-state imaging device according to the first embodiment.

FIG. 5 is a cross-sectional view illustrating a modified example of the pixel array unit provided to the solid-state imaging device according to the first embodiment.

FIG. 6 is a diagram illustrating a configuration example of a signal readout circuit for one column according to the first embodiment.

FIG. 7 is a diagram illustrating a first example of a waveform of each unit at a time when the imaging device according to the first embodiment reads out a signal.

FIG. 8 is a diagram illustrating a second example of a waveform of each unit at a time when the imaging device according to the first embodiment reads out a signal.

FIG. 9 is a diagram illustrating a configuration example of the signal readout circuit for one column according to a second embodiment.

FIG. 10 is a diagram illustrating a configuration example of the signal readout circuit for three columns according to a third embodiment.

FIG. 11 is a diagram illustrating a configuration example of the signal readout circuit for one column according to a fourth embodiment.

FIG. 12 is a diagram illustrating an example of a waveform of each unit at a time when the signal readout circuit reads out a constant current according to the fourth embodiment.

FIG. 13 is a diagram illustrating a configuration example of the signal readout circuit for one column according to a fifth embodiment.

FIG. 14 is a diagram illustrating an example of a waveform of each unit at a time of readout of a signal according to the fifth embodiment.

FIG. 15 is a diagram illustrating a configuration example of the signal readout circuit for one column according to a sixth embodiment.

FIG. 16 is a diagram illustrating an example of a waveform of each unit at a time of readout of a signal according to the sixth embodiment.

FIG. 17 is a diagram illustrating a configuration example of the signal readout circuit for one column according to a seventh embodiment.

FIG. 18 is a diagram illustrating a configuration example of the signal readout circuit for two columns according to an eighth embodiment.

FIG. 19 is a diagram illustrating a configuration example of a comparator that is applied to the signal readout circuit according to the eighth embodiment.

FIG. 20 is a diagram illustrating an example of a waveform of each unit at a time when the imaging device according to the eighth embodiment reads out a signal.

FIG. 21 is a diagram illustrating an example of a waveform of each unit at a time when the imaging device according to a comparative example of the eighth embodiment reads out a signal.

FIG. 22 is a diagram illustrating a configuration example of the signal readout circuit for one column according to a ninth embodiment.

FIG. 23 is a diagram illustrating a configuration example of the signal readout circuit for one column according to a tenth embodiment.

FIG. 24 is a perspective view illustrating a configuration example of the imaging device according to an eleventh embodiment.

FIG. 25 is a block diagram illustrating a schematic configuration example of a vehicle control system.

FIG. 26 is an explanatory diagram illustrating an example of an installation position of an imaging section.

### DESCRIPTION OF EMBODIMENTS

Modes for carrying out the present technology (hereinafter also referred to as “embodiments”) will be described below. The description will be given in the following order.
1. First Embodiment (an example where a signal line clip transistor is connected via a signal line clip selection transistor electrically connected to a vertical signal line)
2. Second Embodiment (an example where a signal line clip transistor and a signal line clip selection transistor are provided to an upper layer chip provided with a pixel, and a signal clip voltage setting unit is provided to a lower layer chip)
3. Third Embodiment (an example where a driver that drives the signal line clip selection transistor and a driver that drives the signal line reset transistor are provided).
4. Fourth Embodiment (an example where a constant current transistor is connected in parallel to a series circuit of the signal line reset transistor and a diode connection transistor)
5. Fifth Embodiment (an example where the signal line clip transistor clips the potential of a signal line and selects a selection signal line)
6. Sixth Embodiment (an example where an amplifier transistor of an Optical Black (OB) pixel is used as the signal line clip transistor, and a selection transistor of the OB pixel is used as the signal line clip selection transistor)
7. Seventh Embodiment (an example where a resistance ladder circuit is used to set a clip level of the signal line, and is used to set a reset level of the signal line)
8. Eighth Embodiment (an example where readout of a capacitive load that uses the series circuit of the signal line transistor and a diode connection transistor is applied to edge detection)
9. Ninth Embodiment (an example where readout of the capacitive load that uses the series circuit of the signal line transistor and the diode connection transistor is applied to a cell in which the amplifier transistor is shared between four photodiodes)
10. Tenth Embodiment (an example where readout of the capacitive load that uses the series circuit of the signal line transistor and the diode connection transistor is applied to binning readout)
11. Eleventh Embodiment (an example where substrates on each of which a solid-state imaging device has been formed are stacked).
12. Example of Application to Moving Body

### 1. First Embodiment

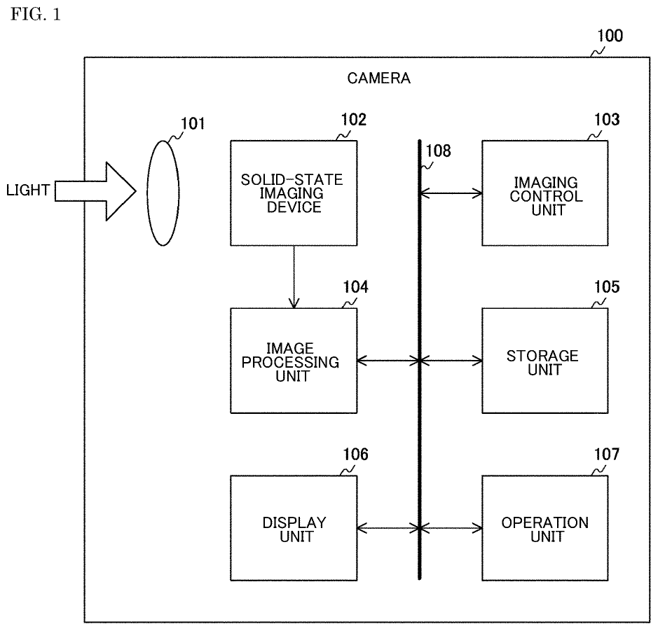

FIG. 1 is a block diagram illustrating a configuration example of a camera to which an imaging device according to the first embodiment is applied.

In FIG. 1, a camera 100 includes an optical system 101, a solid-state imaging device 102, an imaging control unit 103, an image processing unit 104, a storage unit 105, a display unit 106, and an operation unit 107. The imaging control unit 103, the image processing unit 104, the storage unit 105, the display unit 106, and the operation unit 107 are connected with each other via a bus 108.

Note that the camera 100 may be used alone, or may be incorporated in a portable terminal such as a smartphone, or may be incorporated in an authentication device or a monitoring device.

The optical system 101 causes light from a subject to be incident on the solid-state imaging device 102, and forms a subject image on a light receiving surface of the solid-state imaging device 102. The optical system 101 can include, for example, a focus lens, a zoom lens, a diaphragm, and the like. The optical system 101 may include a plurality of lenses such as wide angle lenses, normal lenses, and telephoto lenses.

The solid-state imaging device 102 converts light from the subject into an electrical signal per pixel, digitizes this electrical signal, and outputs the digitized signal. For example, the solid-state imaging device 102 may be a Complementary Metal Oxide Semiconductor (CMOS) image sensor, or may be a Charge Coupled Device (CCD).

The imaging control unit 103 controls imaging of the solid-state imaging device 102 based on a command from the operation unit 107. At this time, the imaging control unit 103 can control an exposure time, an exposure amount, an imaging timing, and the like of the solid-state imaging device 102.

The image processing unit 104 performs image processing based on an output from the solid-state imaging device 102. The image processing is, for example, gamma correction, white balance processing, sharpness processing, gradation conversion processing. The image processing unit 104 may include a processor that executes processing based on software.

The storage unit 105 stores captured images captured by the solid-state imaging device 102, and stores imaging parameters of the solid-state imaging device 102. Furthermore, the storage unit 105 can store a program that causes the camera 100 to operate based on the software. The storage unit 105 may include a Read Only Memory (ROM), a Random Access Memory (RAM), and a memory card.

The display unit 106 displays captured images or displays various pieces of information for supporting an imaging operation. The display unit 106 may be a liquid crystal display or may be an organic Electro Luminescence (EL) display.

The operation unit 107 provides a user interface for operating the camera 100. The operation unit 107 may include buttons, dials, and switches provided to the camera 100. The operation unit 107 may be configured as a touch panel together with the display unit 106.

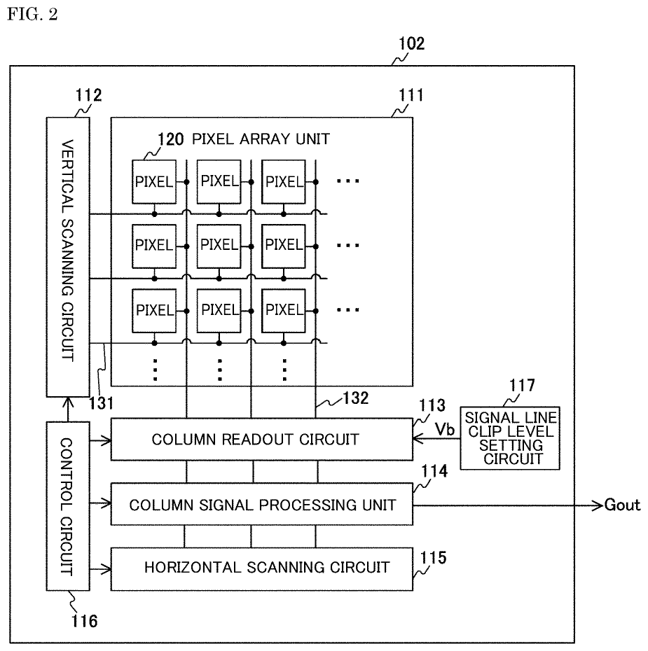

FIG. 2 is a block diagram illustrating a configuration example of a solid-state imaging device according to the first embodiment.

In FIG. 2, the solid-state imaging device 102 includes a pixel array unit 111, a vertical scanning circuit 112, a column readout circuit 113, a column signal processing unit 114, a horizontal scanning circuit 115, a control circuit 116, and a signal line clip level setting circuit 117.

The pixel array unit 111 includes a plurality of pixels 120. The pixels 120 are aligned in a matrix along a row direction (also referred to as a horizontal direction) and a column direction (also referred to as a vertical direction). Each pixel 120 can configure a source follower between each pixel 120 and the column readout circuit 113 at a time of readout of a signal. Each pixel 120 is connected to a horizontal drive line 131 per row, and is connected to a vertical signal line 132 per column. The horizontal drive line 131 drives each pixel 120 per row at the time of readout of the signal from each pixel 120. The vertical signal line 132 sends to the column signal processing unit 114 per column the potential that is based on a charge stored according to a current flowing at the time of readout of the signal from each pixel 120. Note that the vertical signal line 132 is an example of a signal line recited in the claims.

The vertical scanning circuit 112 scans the readout target pixel 120 in the column direction. The vertical scanning circuit 112 may be configured using a vertical register.

The column readout circuit 113 can configure a source follower between the column readout circuit 113 and each pixel 120 at a time of readout of a signal from each pixel 120. At this time, the column readout circuit 113 can change the potential of the vertical signal line 132 based on the charge held in the pixel 120. The column readout circuit 113 can support readout of a capacitive load. The column readout circuit 113 may also support readout of a constant current. Furthermore, the column readout circuit 113 sets the potential of the vertical signal line 132 to a clip level at a time of P phase VSL settling of readout of the capacitive load. This clip level can be set to a higher potential than the potential of the vertical signal line 132 at the time of readout of a signal from the pixel 120 in a case where a charge overflows from a photodiode to a floating diffusion. Furthermore, the column readout circuit 113 may set the potential of the vertical signal line 132 to the clip level at the time of P phase VSL settling of readout of a constant current, too.

The column signal processing unit 114 processes a signal sent from each pixel 120 to the column direction. For example, the column signal processing unit 114 can perform Correlated Double Sampling (CDS) processing based on the signal sent from each pixel 120 to the column direction. Furthermore, the column signal processing unit 114 can perform Analog to Digital (AD) conversion processing based on the signal sent from each pixel 120 to the column direction, and output an imaging signal Gout.

The horizontal scanning circuit 115 scans the readout target pixel 120 in the row direction. The horizontal scanning circuit 115 may be configured using a horizontal register.

The control circuit 116 controls the vertical scanning circuit 112, the column readout circuit 113, the column signal processing unit 114, and the horizontal scanning circuit 115. For example, the control circuit 116 can control a scanning timing in the column direction, a scanning timing in the row direction, an operation timing of the column readout circuit 113, and a processing timing of the column signal processing unit 114.

The signal line clip level setting circuit 117 sets a signal line clip voltage Vb used to generate the clip level of the potential of the vertical signal line 132. The signal line clip voltage Vb is supplied to the column readout circuit 113, and is used to generate the clip level of the potential of the vertical signal line 132. The signal line clip level setting circuit 117 may be used to generate the reset level of the potential of the vertical signal line 132.

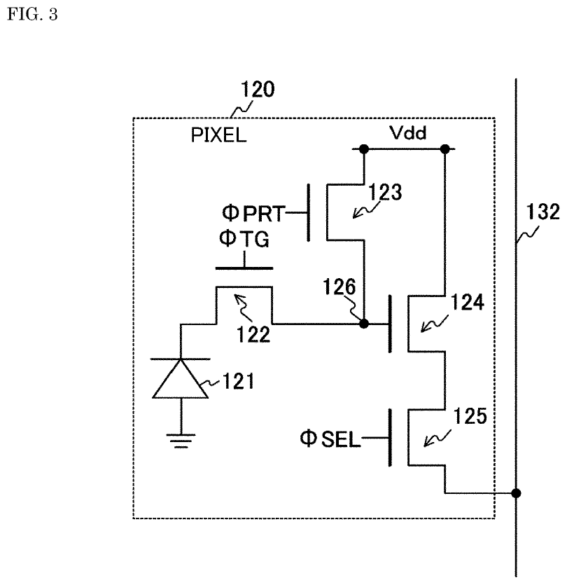

FIG. 3 is a block diagram illustrating a circuit configuration example of a pixel provided to the solid-state imaging device according to the first embodiment.

In FIG. 3, the pixel 120 includes a photodiode 121, a transfer transistor 122, a reset transistor 123, an amplifier transistor 124, a selection transistor 125, and a floating diffusion 126. As the transfer transistor 122, the reset transistor 123, the amplifier transistor 124, and the selection transistor 125, Metal Oxide Semiconductor (MOS) transistors can be used.

The amplifier transistor 124 and the selection transistor 125 are connected in series. A cathode of the photodiode 121 is connected to the floating diffusion 126 via the transfer transistor 122. Furthermore, the floating diffusion 126 is connected to a power supply Vdd via the reset transistor 123. Furthermore, the power supply Vdd is connected to the vertical signal line 132 via the series circuit of the amplifier transistor 124 and the selection transistor 125. A gate of the amplifier transistor 124 is connected to the floating diffusion 126.

A gate of the transfer transistor 122 is applied a transfer signal ΦTG. A gate of the reset transistor 123 is applied a pixel reset signal ΦPRT. A gate of the selection transistor 125 is applied a selection signal ΦSEL. The transfer signal QTG, the pixel reset signal ΦPRT, and the selection signal ΦSEL can be sent to each pixel 120 via the horizontal drive line 131 in FIG. 2.

Next, when the transfer transistor 122 is turned on, the charge stored in the photodiode 121 is transferred to the floating diffusion 126. Furthermore, when the selection transistor 125 is turned on, a source potential of the amplifier transistor 124 changes according to the potential of the floating diffusion 126. Furthermore, the source potential of the amplifier transistor 124 is applied to the vertical signal line 132 via the selection transistor 125, and is sent via the vertical signal line 132. Furthermore, when the reset transistor 123 is turned on, the charge stored in the floating diffusion 126 is discharged.

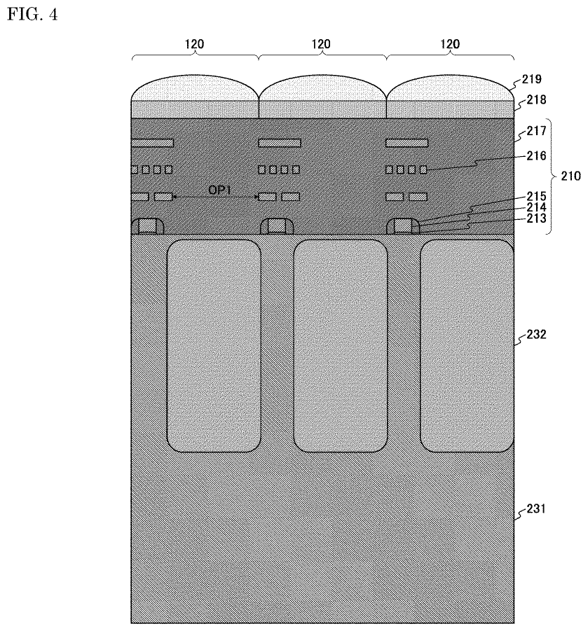

FIG. 4 is a cross-sectional view illustrating a configuration example of a pixel array unit provided to the solid-state imaging device according to the first embodiment. Note that FIG. 4 illustrates an example of a front-illuminated type solid-state imaging device. Furthermore, FIG. 4 illustrates a configuration example of three pixels.

In FIG. 4, a photodiode 232 is formed on a semiconductor substrate 231 per pixel 120. A material of the semiconductor substrate 231 may be Si, may be InGaAs, or may be InP.

A gate electrode 214 and a wiring layer 210 are formed on the semiconductor substrate 231. The gate electrode 214 is formed on the semiconductor substrate 231 with a gate insulating film 213 interposed therebetween. A sidewall 215 is formed on a sidewall of the gate electrode 214. As a material of the gate electrode 214, for example, polycrystalline silicon doped with impurities can be used. For example, a silicon oxide film can be used as a material of the gate insulating film 213. As a material of the sidewall 215, for example, a silicon oxide film or a silicon nitride film can be used.

The gate electrode 214 can be used for the pixel transistor. The pixel transistor includes the transfer transistor 122, the reset transistor 123, the amplifier transistor 124, and the selection transistor 125 in FIG. 3.

A wiring 216 is formed on the gate electrode 214. FIG. 4 illustrates an example of a three-layer wiring. At this time, the wiring 216 is provided with an opening part OP1 that allows light to be incident on the photodiode 232. The gate electrode 214 and the wiring 216 are insulated with an insulation layer 217 interposed therebetween. For example, a silicon oxide film can be used for the insulation layer 217. For example, a metal such as Al or Cu can be used as the material for the wiring 216.

A color filter 218 is formed on the wiring layer 210 per pixel 120. A microlens 219 is formed on the color filter 218 per pixel 120. As materials of the color filter 218 and the microlens 219, an acrylic or polycarbonate transparent resin can be used. A pigment may be added for coloring to the color filter 218. The color filter 218 can form, for example, a Bayer layout.

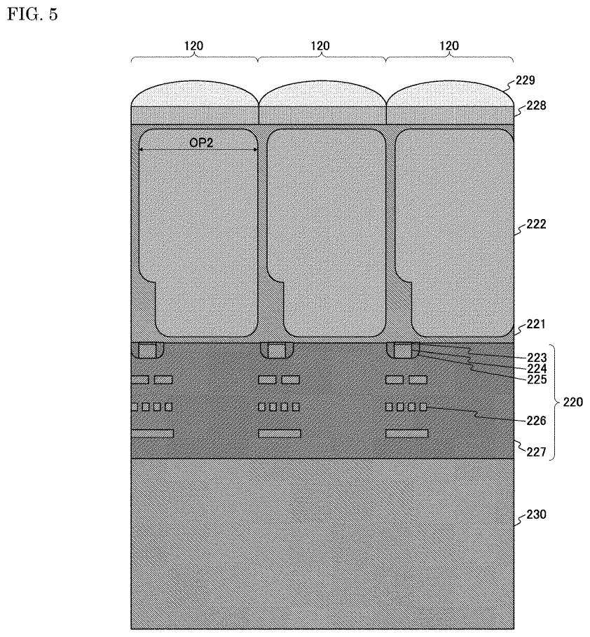

FIG. 5 is a cross-sectional view illustrating a modified example of a pixel array unit provided to the solid-state imaging device according to the first embodiment. Note that FIG. 5 illustrates an example of a back illuminated type solid-state imaging device. Furthermore, FIG. 5 illustrates a configuration example of three pixels.

In FIG. 5, a photodiode 222 is formed in a semiconductor layer 221 per pixel 120. A material of the semiconductor layer 221 may be Si, may be InGaAs, or may be InP. The semiconductor layer 221 can be formed by thinning from a back surface side a semiconductor substrate including the photodiode 222 formed on a front surface side.

A gate electrode 224 and a wiring layer 220 are formed on the semiconductor layer 221. The gate electrode 224 is formed on the semiconductor layer 221 with a gate insulating film 223 interposed therebetween. A sidewall 225 is formed on a sidewall of the gate electrode 224.

The gate electrode 224 can be used for the pixel transistor. The pixel transistor includes the transfer transistor 122, the reset transistor 123, the amplifier transistor 124, and the selection transistor 125 in FIG. 3.

A wiring 226 is formed on the gate electrode 224. FIG. 5 illustrates an example of a three-layer wiring. The gate electrode 224 and the wiring 226 are insulated with an insulation layer 227 interposed therebetween. The semiconductor layer 221 is supported on a support substrate 230 with the insulation layer 227 interposed therebetween. The support substrate 230 may be a glass substrate, may be an Si support substrate, or may be a sapphire substrate.

A color filter 228 is formed on a back surface side of the semiconductor layer 221 per pixel 120. A microlens 229 is formed on the color filter 228 per pixel 120. The color filter 228 can form, for example, a Bayer layout.

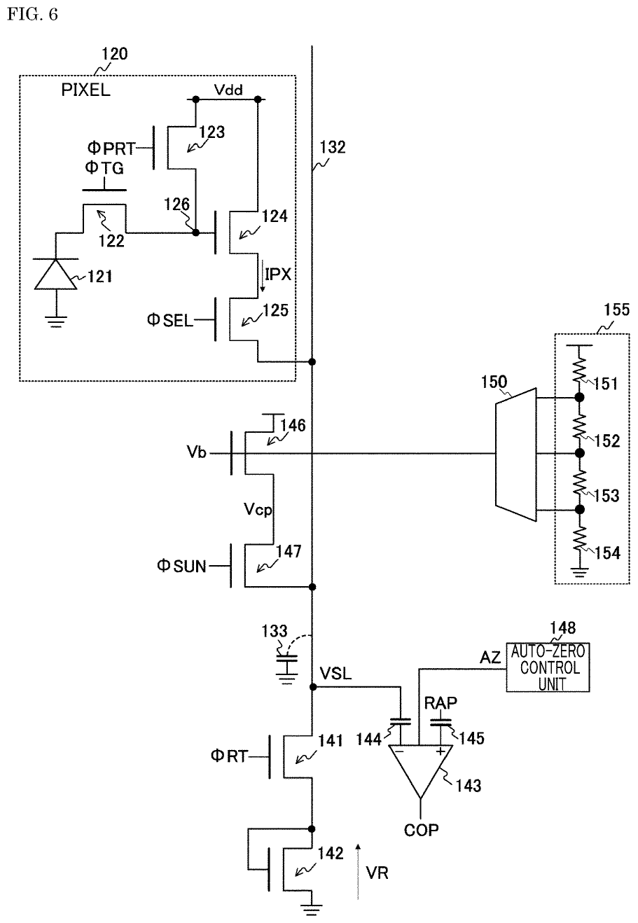

FIG. 6 is a diagram illustrating a configuration example of the signal readout circuit for one column according to the first embodiment.

In FIG. 6, the amplifier transistor 124 is connected to the vertical signal line 132 via the selection transistor 125. Furthermore, a capacitance 133 is added to the vertical signal line 132. This capacitance 133 may be a parasitic capacitance of the vertical signal line 132, or may be a capacitive element connected to the vertical signal line 132.

Furthermore, the vertical signal line 132 is electrically connected with a signal line reset transistor 141. The signal line reset transistor 141 can reset a potential VSL of the vertical signal line 132. As the signal line reset transistor 141, for example, a MOS transistor can be used. A gate of the signal line reset transistor 141 is applied a signal line reset signal ΦRT.

The signal line reset transistor 141 is connected in series with a diode connection transistor 142. As the diode connection transistor 142, for example, a MOS transistor can be used. At this time, a gate of the diode connection transistor 142 is connected to a drain of the diode connection transistor 142. A source of the diode connection transistor 142 is grounded. The source of the diode connection transistor 142 may be connected to a higher potential than a ground potential. The diode connection transistor 142 can generate a voltage (e.g., 0.5 V) higher than 0 V, and set the potential VSL of the vertical signal line 132 to the potential higher than 0 V via the signal line reset transistor 141. Note that the diode connection transistor 142 is an example of a signal line reset level generation unit recited in the claims.

Furthermore, the vertical signal line 132 is electrically connected with the signal line clip transistor 146. The signal line clip transistor 146 clips the potential VSL of the vertical signal line 132. As the signal line clip transistor 146, for example, a MOS transistor can be used. A gate of the signal line clip transistor 146 is applied the signal line clip voltage Vb. The signal line clip transistor 146 can generate a clip level Vcp based on the signal line clip voltage Vb. The signal line clip voltage Vb can be made lower than the reset level of the pixel 120.

A signal line clip selection transistor 147 is connected between the signal line clip transistor 146 and the vertical signal line 132. The signal line clip selection transistor 147 applies the clip level Vcp generated by the signal line clip transistor 146 to the vertical signal line 132. A plurality of the clip levels Vcp may be provided and be able to be switched. As the signal line clip selection transistor 147, for example, a MOS transistor can be used. A gate of the signal line clip selection transistor 147 is applied a signal line clip selection signal ΦSUN.

A resistance ladder circuit 155 generates the signal line clip voltage Vb stepwise. The resistance ladder circuit 155 includes voltage divider resistances 151 to 154. The voltage divider resistances 151 to 154 are connected with each other in series. A selector 150 switches divided voltages generated by the voltage divider resistances 151 to 154, and inputs the divided voltage as the signal line clip voltage Vb to the gate of the signal line clip transistor 146. Note that the selector 150 and the resistance ladder circuit 155 are examples of signal line clip voltage setting units recited in the claims. Note that, although FIG. 6 illustrates the example where the signal line clip voltage Vb can be switched at three stages, the stages are not necessarily limited to three stages, and may be, for example, two stages or four stages or more.

The vertical signal line 132 is connected to an inverting input of a comparator 143 via a DC cut capacitor 144. At this time, the inverting input of the comparator 143 is applied the potential VSL of the vertical signal line 132 via the DC cut capacitor 144. A non-inverting input of the comparator 143 receives an input of a reference signal RAP via the DC cut capacitor 145. The reference signal RAP is, for example, a ramp signal. Furthermore, the comparator 143 receives an input of an auto-zero signal AZ.

An auto-zero control unit 148 inputs the auto-zero signal AZ to the comparator 143. The auto-zero signal AZ activates an auto-zero operation during an auto-zero period. At this time, the auto-zero control unit 148 can control charges stored in the DC cut capacitors 144 and 145 such that the non-inverting input and the inverting input of the comparator 143 balance.

Here, when the signal line reset transistor 141 is turned on before a signal is read out from the pixel 120, the potential VSL of the vertical signal line 132 is set to the potential higher than 0 V. Furthermore, after the signal line reset transistor 141 is turned off, the selection transistor 125 and the signal line clip selection transistor 147 are turned on. At this time, when high brightness light such as sunlight is incident on the pixel 120, the potential VSL of the vertical signal line 132 is clipped to the clip level Vcp by the signal line clip transistor 146 at a time of P phase VSL settling of readout of the capacitive load. Hence, even when a charge overflows from the photodiode 121 to the floating diffusion 126, the potential VSL can be set to a higher potential than the potential of the vertical signal line 132 at the time of readout of the signal from the pixel 120. Furthermore, the comparator 143 compares the potential VSL of the vertical signal line 132 with the reference signal RAP, and outputs a comparison result COP. At this time, the potential VSL of the vertical signal line 132 is clipped to the clip level Vcp at the time of P phase VSL settling of readout of the capacitive load, so that it is possible to prevent the sunspot phenomenon.

On the other hand, when normal light or low brightness light is incident on the pixel 120, the charge of the potential VSL of the vertical signal line 132 corresponding to a pixel current IPX flowing to the vertical signal line 132 via the selection transistor 125 is stored in the capacitance 133, and the potential VSL of the vertical signal line 132 changes based on the charge stored in the capacitance 133. Furthermore, the comparator 143 compares the potential VSL of the vertical signal line 132 with the reference signal RAP, and outputs the comparison result COP.

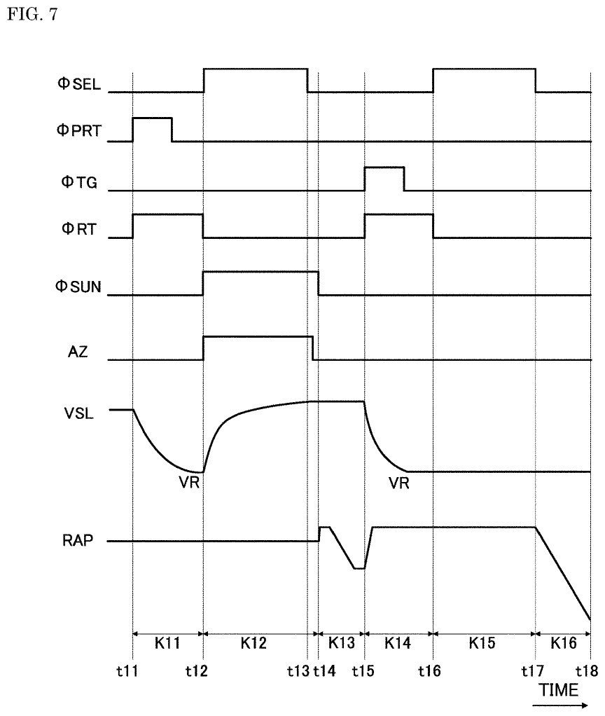

FIG. 7 is a diagram illustrating a first example of a waveform of each unit at a time when the imaging device according to the first embodiment reads out a signal. Note that FIG. 7 illustrates the waveform of each unit at the time of readout of a signal when high brightness light such as sunlight is incident on the pixel 120.

In FIG. 7, when the imaging device reads out the capacitive load, pixel reset/VSL reset are performed (K11). At this time, the pixel reset signal ΦPRT rises (t11), the reset transistor 123 is turned on, and the floating diffusion 126 is reset.

Note that the reset level of the floating diffusion 126 can be set to the power supply potential Vdd. Furthermore, a signal line reset signal ΦRT rises (t11), the signal line reset transistor 141 is turned on, and the vertical signal line 132 is reset. In this case, when the signal line reset transistor 141 is turned on, the current flows to the diode connection transistor 142 via the signal line reset transistor 141. Hence, the reset level of the vertical signal line 132 is set to a potential (e.g., 0.5 V) higher than 0 V by a forward voltage VR of the diode connection transistor 142. Note that a rising timing of the pixel reset signal ΦPRT and a rising timing of the signal line reset signal RT may not necessarily be the same time, and may be shifted from each other. Furthermore, a falling timing of the signal line reset signal ΦRT does not need to come after a falling timing of the pixel reset signal ΦPRT, and is not particularly limited as long as the falling timing comes before the selection signal ΦSEL rises.

Next, P phase VSL settling is performed (K12). At this time, the signal line reset signal ΦRT falls and the selection signal ΦSEL rises (t12), and the selection transistor 125 is turned on. Furthermore, an output of the resistance ladder circuit 155 is selected such that the signal line clip voltage Vb becomes lower than the reset level of the pixel 120, and the signal line clip voltage Vb is applied to a gate of the signal line clip transistor 146. Furthermore, the signal line clip selection signal ΦSUN rises (t12) and the signal line clip selection transistor 147 is turned on, and the auto-zero signal AZ rises (t12) and the auto-zero operation of the comparator 143 is activated. Furthermore, after the selection signal ΦSEL falls (t13), the auto-zero signal AZ falls and, after the auto-zero signal AZ falls, the signal line clip selection signal ΦSUN falls (t14). At this time, the potential VSL of the vertical signal line 132 is clipped to the clip level Vcp, and is adjusted such that the non-inverting input and the inverting input of the comparator 143 balance when the potential VSL of the vertical signal line 132 is clipped.

Next, P phase AD is performed (K13). At this time, after the signal line clip selection signal ΦSUN falls (t14), a ramp signal is supplied as the reference signal RAP to the comparator 143. Furthermore, the comparator 143 compares with the reference signal RAP the potential VSL of the vertical signal line 132 matching the clip level Vcp, and outputs as the comparison result COP a timing at which a level of the reference signal RAP matches with the potential VSL of the vertical signal line 132. At this time, based on a counting operation performed until the level of the reference signal RAP matches with the potential VSL of the vertical signal line 132, the clip level Vcp set to the vertical signal line 132 is subjected to AD conversion.

Next, transfer/VSL reset is performed (K14). At this time, the transfer signal ΦTG rises (t15), the transfer transistor 122 is turned on, and the charge stored in the photodiode 121 is transferred to the floating diffusion 126. Furthermore, the signal line reset signal ΦRT rises (t15), the signal line reset transistor 141 is turned on, and the vertical signal line 132 is reset. At this time, when the signal line reset transistor 141 is turned on, the current flows to the diode connection transistor 142 via the signal line reset transistor 141. Hence, the reset level of the vertical signal line 132 is set to a potential (e.g., 0.5 V) higher than 0 V by the forward voltage VR of the diode connection transistor 142. Note that a rising timing of the transfer signal ΦTG and a rising timing of the signal line reset signal ΦRT may not necessarily be the same time, and may be shifted from each other. Furthermore, a falling timing of the signal line reset signal ΦRT does not need to come after a falling timing of the transfer signal ΦTG, and is not particularly limited as long as the falling timing comes before the selection signal ΦSEL rises.

Next, D phase VSL settling is performed (K15). At this time, the signal line reset signal ΦRT falls, the selection signal ΦSEL rises (t16), and the selection transistor 125 is turned on. Furthermore, based on a source follower operation of the amplifier transistor 124, the pixel current IPX matching a signal level of the floating diffusion 126 flows to the vertical signal line 132 via the selection transistor 125. Furthermore, the charge matching this pixel current IPX is stored in the capacitance 133, and the potential VSL of the vertical signal line 132 is set based on the charge stored in the capacitance 133.

Next, D phase AD is performed (K16). At this time, the selection signal ΦSEL falls (t17), and the ramp signal is supplied as the reference signal RAP to the comparator 143 (t17 to t18). Furthermore, the comparator 143 compares with the reference signal RAP the potential VSL of the vertical signal line 132 matching the signal level, and outputs as the comparison result COP a timing at which the level of the reference signal RAP matches with the potential VSL of the vertical signal line 132. At this time, based on a counting operation performed until the level of the reference signal RAP matches with the potential VSL of the vertical signal line 132, the signal level read out from the pixel 120 is subjected to AD conversion.

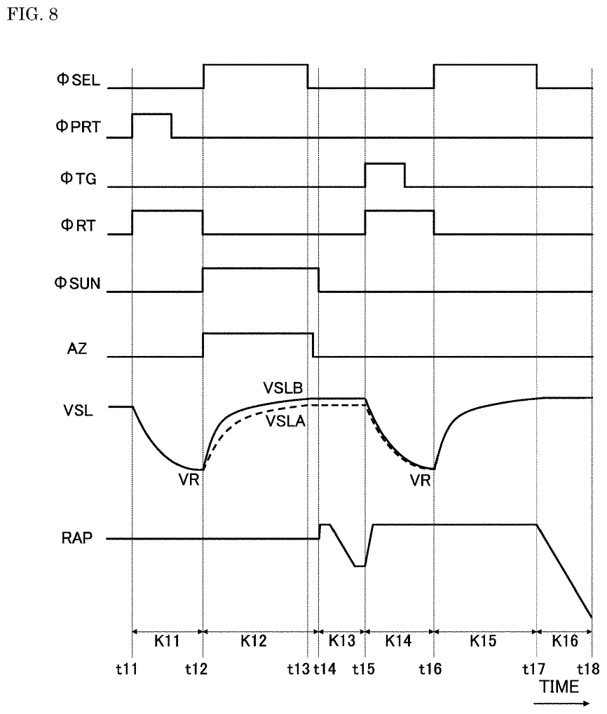

FIG. 8 is a diagram illustrating a second example of a waveform of each unit at a time when the imaging device according to the first embodiment reads out a signal. Note that FIG. 8 illustrates the waveform of each unit at the time of readout of a signal when normal light is incident on the pixel 120.

In FIG. 8, a signal readout operation at a time when the normal light is incident on the pixel 120 is similar to a signal readout operation at a time when high brightness light such as sunlight is incident on the pixel 120. In this regard, according to the signal readout operation at the time when the normal light is incident on the pixel 120, the charge does not overflow from the photodiode 121 to the floating diffusion 126 during P phase VSL settling (K12). Furthermore, when the selection transistor 125 is turned on, the pixel current IPX matching the reset level of the floating diffusion 126 flows to the vertical signal line 132 via the selection transistor 125 based on the source follower operation of the amplifier transistor 124. Furthermore, the charge matching this pixel current IPX is stored in the capacitance 133, and the potential VSL of the vertical signal line 132 is set based on the charge stored in the capacitance 133. At this time, the signal line clip voltage Vb is set to a voltage lower than the reset level of the pixel 120, and the signal line clip selection transistor 147 is turned on. Hence, the vertical signal line 132 is also driven by the signal line clip transistor 146 while being driven by the amplifier transistor 124. Consequently, P phase VSL settling VSLB that is provided with the signal line clip transistor 146 can reduce a settling time compared to P phase VSL settling VSLA that is not provided with the signal line clip transistor 146.

As described above, in the above-described first embodiment, the signal line clip transistor 146 is electrically connected via the signal line clip selection transistor 147 connected to the vertical signal line 132. Consequently, it is possible to clip the potential VSL of the vertical signal line 132 without depending on an incident light amount, and it is possible to prevent the sunspot phenomenon and increase the speed of P phase VSL settling.

Furthermore, by resetting the vertical signal line 132 at the time of readout of a signal from the pixel 120, it is possible to store in the capacitance 133 the charge matching the pixel current IPX that flows at the time of readout of the signal from the pixel 120. Consequently, it is not necessary to cause the constant current matching the signal read out from the pixel 120 to flow to the vertical signal line 132 to detect the signal read out from the pixel 120, and it is possible to reduce a consumption current at the time of readout of the signal from the pixel 120.

### 2. Second Embodiment

In the above-described first embodiment, the signal line clip transistor 146 is electrically connected via the signal line clip selection transistor 147 connected to the vertical signal line 132. In this second embodiment, the signal line clip transistor 146 and the signal line clip selection transistor 147 are provided to an upper layer chip provided with the pixel 120, and the resistance ladder circuit 155 and the selector 150 are provided to a lower layer chip.

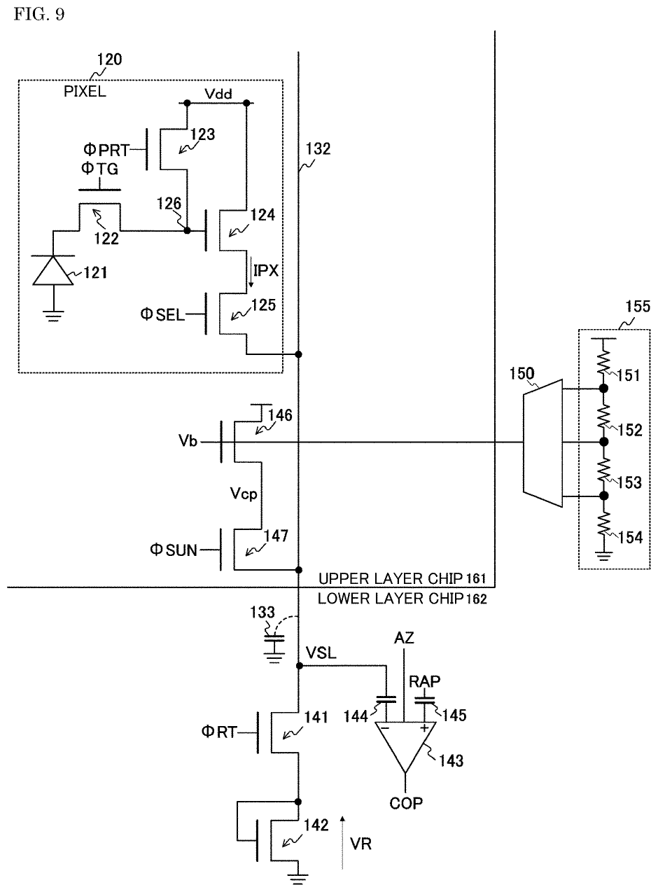

FIG. 9 is a diagram illustrating a configuration example of the signal readout circuit for one column according to the second embodiment.

In FIG. 9, a circuit configuration of this signal readout circuit is similar to a circuit configuration of the signal readout circuit in FIG. 6. In this regard, this signal readout circuit is formed in a stacked chip. This stacked chip includes an stacked on the lower layer chip 162.

On the upper layer chip 161, the pixel 120, the vertical signal line 132, the signal line clip transistor 146, and the signal line clip selection transistor 147 are formed. In this case, a gate length and a gate width of the signal line clip transistor 146 can be made equal to a gate length and a gate width of an amplifier transistor 124 of the pixel 120. A gate length and a gate width of the signal line clip selection transistor 147 can be made equal to a gate length and a gate width of a selection transistor 125 of the pixel 120.

On the lower layer chip 162, the signal line reset transistor 141, the diode connection transistor 142, the comparator 143, the resistance ladder circuit 155, and the selector 150 are formed. In this case, the vertical signal line 132 can be wired from the upper layer chip 161 to the lower layer chip 162.

As described above, in the above-described second embodiment, the signal line clip transistor 146 and the signal line clip selection transistor 147 are formed in the upper layer chip 161 in which the pixel 120 has been formed. Consequently, it is possible to equalize characteristics variations of the pixel transistor provided to the pixel 120, and characteristics variations of the signal line clip transistor 146 and the signal line clip selection transistor 147.

### 3. Third Embodiment

In the above-described first embodiment, the signal line clip transistor 146 is electrically connected via the signal line clip selection transistor 147 connected to the vertical signal line 132. In this third embodiment, a driver that drives the signal line clip selection transistor 147 and a driver that drives the signal line reset transistor 141 are provided to a peripheral circuit of the pixel 120.

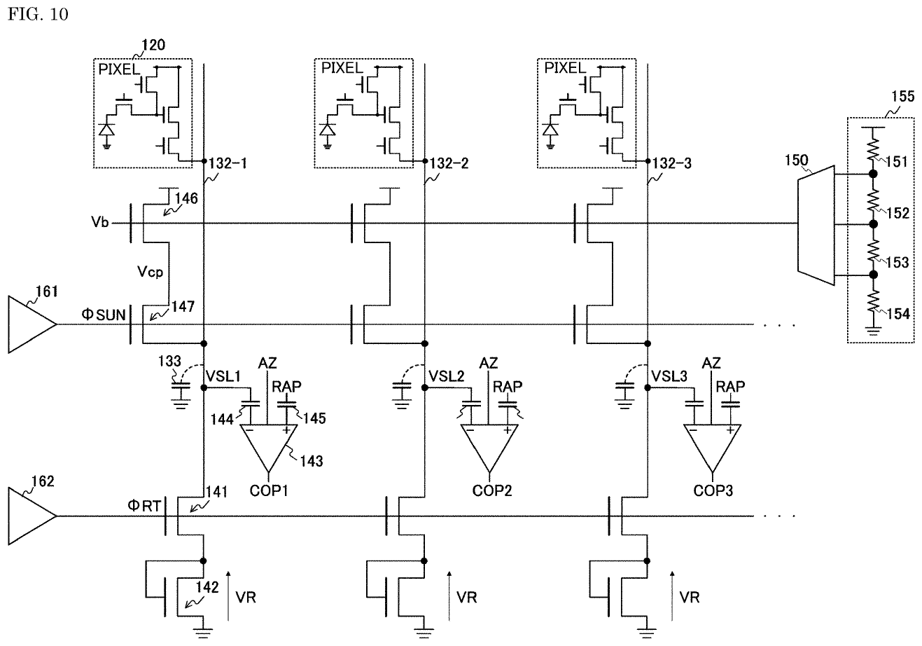

FIG. 10 is a diagram illustrating a configuration example of the signal readout circuit for three columns according to the third embodiment.

In FIG. 10, the signal line reset transistor 141, the diode connection transistor 142, the comparator 143, the signal line clip transistor 146, and the signal line clip selection transistor 147 are provided to each column.

A driver 161 drives the signal line clip selection transistor 147. A driver 162 drives the signal line reset transistor 141. The drivers 161 and 162 are provided to the peripheral circuit of the pixel 120. The driver 161 shares a plurality of the signal line clip selection transistors 147 whose columns are respectively different. The driver 162 shares a plurality of the signal line reset transistors 141 whose columns are respectively different. The resistance ladder circuit 155 and the selector 150 share a plurality of the signal line clip transistors 146 whose columns are respectively different.

As described above, in the above-described third embodiment, the plurality of the signal line clip selection transistors 147 whose columns are respectively different share the driver 161, and the plurality of the signal line reset transistors 141 whose columns are respectively different share the driver 162. Consequently, it is possible to prevent the sunspot phenomenon at the time of readout of the capacitive load while suppressing an increase in occupied areas of the drivers 161 and 162.

### 4. Fourth Embodiment

In the above-described first embodiment, a clipping operation of the potential VSL of the vertical signal line 132 during P phase VSL settling is applied to readout of the capacitive load. This fourth embodiment makes it possible to switch between readout of a current and readout of the capacitive load while implementing a clipping operation of the potential VSL of the vertical signal line 132 during P phase VSL settling.

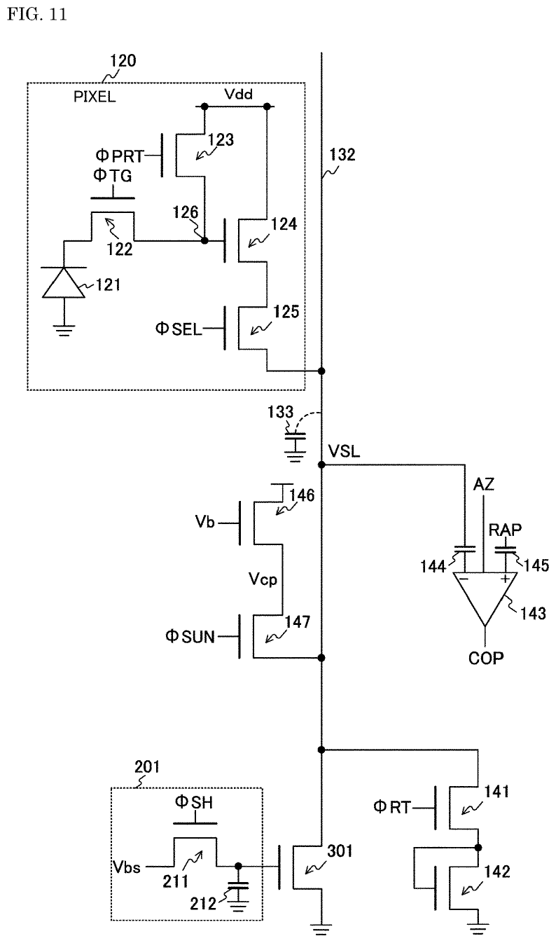

FIG. 11 is a diagram illustrating a configuration example of the signal readout circuit for one column according to the fourth embodiment.

In FIG. 11, this signal readout circuit additionally includes a sample and hold circuit 201 and a constant current transistor 301 in the signal readout circuit according to the above-described first embodiment. Other components of the signal readout circuit according to the fourth embodiment are the same as the components of the signal readout circuit according to the above-described first embodiment.

The sample and hold circuit 201 samples and holds a bias voltage Vbs for causing the constant current transistor 301 to operate, and applies the bias voltage Vbs to a gate of the constant current transistor 301. The sample and hold circuit 201 includes a transistor 211 and a capacitor 212. The transistor 211 may be a MOS transistor. A gate of the transistor 211 is applied a sample and hold signal ΦSH. The capacitor 212 is connected between a source of the transistor 211 and a ground potential.

The constant current transistor 301 is electrically connected to the vertical signal line 132. The constant current transistor 301 may be a MOS transistor.

Here, during readout of the capacitive load, the bias voltage Vbs is set to 0 V, and the sample and hold signal ΦSH is set to a high level. In this case, the constant current transistor 301 is turned off, and the current does not flow to the constant current transistor 301. An operation of the signal readout circuit in this case is the same as that in FIG. 7 or 8.

During readout of the constant current, the transistor 211 is turned on, and the bias voltage Vbs is sampled and held. Furthermore, the transistor 211 is turned off, and the bias voltage Vbs sampled and held by the sample and hold circuit 201 is applied to a gate of the constant current transistor 301. In this case, the constant current transistor 301 is turned on, and the constant current flows to the constant current transistor 301.

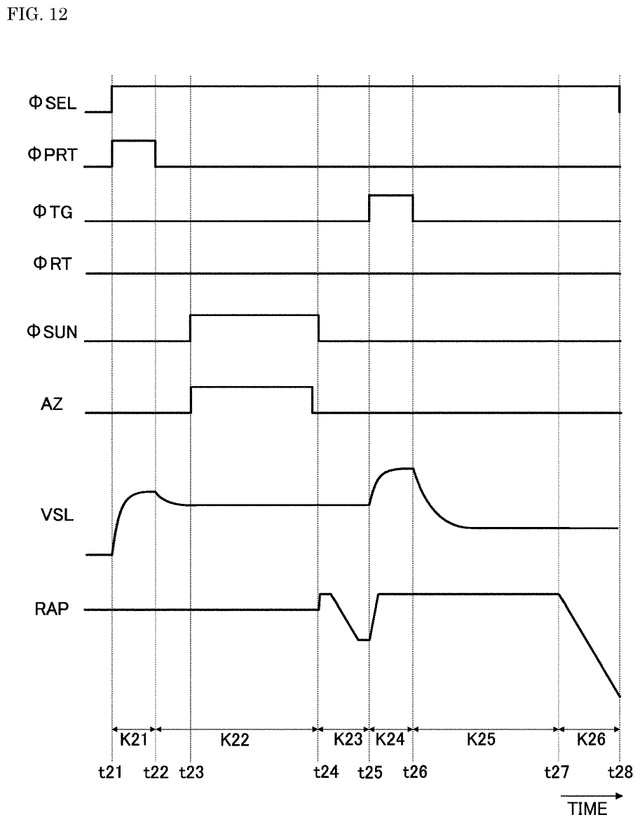

FIG. 12 is a diagram illustrating an example of a waveform of each unit at a time when the signal readout circuit reads out a constant current according to the fourth embodiment. Note that FIG. 12 illustrates the waveform of each unit at the time of readout of a signal when high brightness light such as sunlight is incident on the pixel 120.

In FIG. 12, during readout of the constant current, the transistor 211 is turned on, and the bias voltage Vbs is sampled and held to prevent horizontal streak noise at a time of AD conversion. Furthermore, the transistor 211 is turned off, and the bias voltage Vbs sampled and held by the sample and hold circuit 201 is applied to the gate of the constant current transistor 301.

Next, pixel reset is performed (K21). At this time, the pixel reset signal ΦPRT rises (t21), the reset transistor 123 is turned on, and the floating diffusion 126 is reset. Furthermore, the selection signal ΦSEL rises (t21) and the selection transistor 125 is turned on. At this time, the potential VSL of the vertical signal line 132 is set based on the source follower operation at the time when the power supply potential Vdd is applied to the gate of the amplifier transistor 124.

Next, P phase VSL settling is performed (K22). At this time, the pixel reset signal ΦPRT falls (t22), and the reset transistor 123 is turned off. Furthermore, the potential VSL of the vertical signal line 132 changes based on the source follower operation at the time when the reset level of the floating diffusion 126 is applied to the gate of the amplifier transistor 124. Furthermore, the signal line clip voltage Vb set lower than the reset level of the pixel 120 is applied to the gate of the signal line clip transistor 146. Furthermore, the signal line clip selection signal ΦSUN rises (t23) and the signal line clip selection transistor 147 is turned on, and the auto-zero signal AZ rises (t23) and the auto-zero operation of the comparator 143 is activated. Furthermore, after the auto-zero signal AZ falls, the signal line clip selection signal ΦSUN falls (t24). At this time, the potential VSL of the vertical signal line 132 is clipped to the clip level Vcp, and is adjusted such that the non-inverting input and the inverting input of the comparator 143 balance when the potential VSL of the vertical signal line 132 is clipped.

Next, P phase AD is performed (K23). At this time, the ramp signal is supplied as the reference signal RAP to the comparator 143. Furthermore, the comparator 143 compares with the reference signal RAP the potential VSL of the vertical signal line 132 matching the clip level Vcp, and outputs as the comparison result COP a timing at which the level of the reference signal RAP matches with the potential VSL of the vertical signal line 132. At this time, based on a counting operation performed until the level of the reference signal RAP matches with the potential VSL of the vertical signal line 132, the clip level Vcp set to the vertical signal line 132 is subjected to AD conversion.

Next, transfer is performed (K24). At this time, the transfer signal ΦTG rises (t25), the transfer transistor 122 is turned on, and the charge stored in the photodiode 121 is transferred to the floating diffusion 126. Furthermore, the potential VSL of the vertical signal line 132 is set based on the source follower operation at the time when a cathode potential of the photodiode 121 is applied to the gate of the amplifier transistor 124.

Next, D phase VSL settling is performed (K25). At this time, the transfer signal ΦTG falls (t25), and the transfer transistor 122 is turned off. Furthermore, the potential VSL of the vertical signal line 132 is set based on the source follower operation at the time when the signal level of the floating diffusion 126 is applied to the gate of the amplifier transistor 124.

Next, P phase AD is performed (K26). At this time, the ramp signal is supplied as the reference signal RAP to the comparator 143 (t27 to t28). Furthermore, the comparator 143 compares with the reference signal RAP the potential VSL of the vertical signal line 132 matching the signal level, and outputs as the comparison result COP a timing at which the level of the reference signal RAP matches with the potential VSL of the vertical signal line 132. At this time, based on a counting operation performed until the level of the reference signal RAP matches with the potential VSL of the vertical signal line 132, the signal level read out from the pixel 120 is subjected to AD conversion.

As described above, in the above-described fourth embodiment, the constant current transistor 301 is connected in parallel to a series circuit of the signal line reset transistor 141 and the diode connection transistor 142. The potential VSL of the vertical signal line 132 during P phase VSL setting is clipped. Consequently, it is possible to switch between readout of the constant current and readout of the capacitive load while preventing the sunspot phenomenon.

### 5. Fifth Embodiment

In the above-described first embodiment, the signal line clip transistor 146 is electrically connected via the signal line clip selection transistor 147 connected to the vertical signal line 132. In this fifth Embodiment, the signal line clip transistor 146 clips the potential VSL of the vertical signal line 132 and selects the vertical signal line 132.

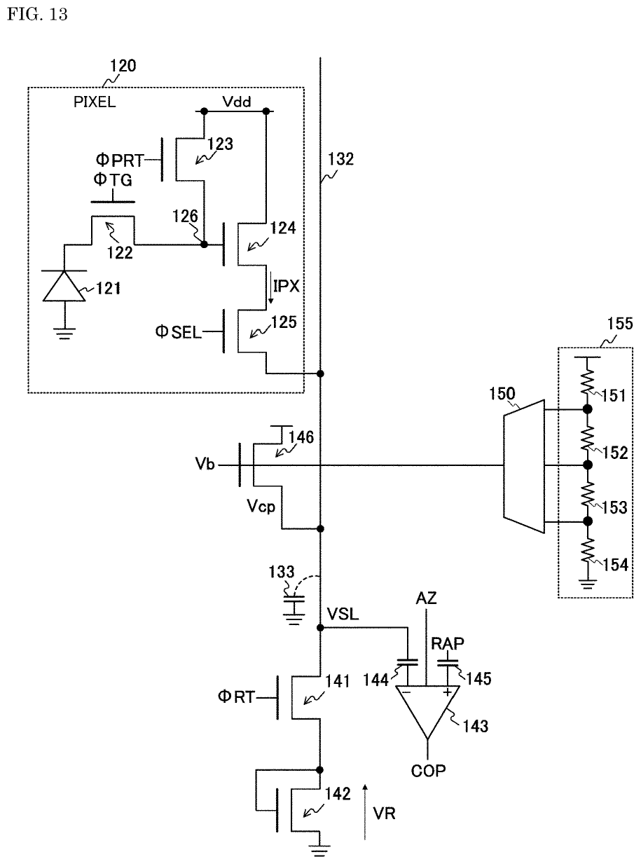

FIG. 13 is a diagram illustrating a configuration example of the signal readout circuit for one column according to the fifth embodiment.

In FIG. 13, in this signal readout circuit, the signal line clip selection transistor 147 is removed from the signal readout circuit according to the above-described first embodiment. Other components of the signal readout circuit according to the fifth embodiment are the same as the components of the signal readout circuit according to the above-described first embodiment.

The signal line clip transistor 146 is directly connected to the vertical signal line 132. In this case, the signal line clip transistor 146 clips the potential VSL of the vertical signal line 132, and selects the vertical signal line 132 in place of the signal line clip selection transistor 147.

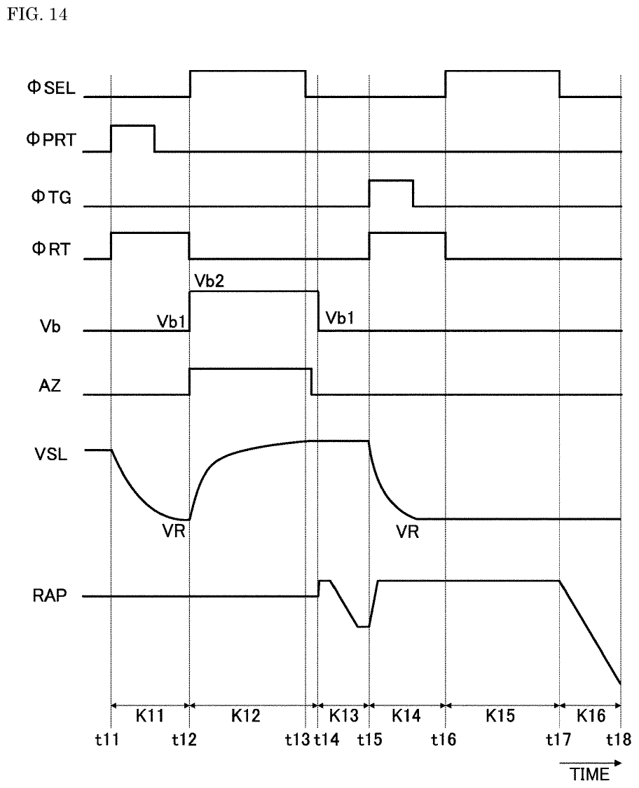

FIG. 14 is a diagram illustrating an example of a waveform of each unit at a time when the signal readout circuit reads out a constant current according to the fifth embodiment. Note that FIG. 14 illustrates the waveform of each unit at the time of readout of a signal when high brightness light such as sunlight is incident on the pixel 120.

In FIG. 14, an operation in a case where the signal line clip selection transistor 147 is not provided is the same as an operation in a case where the signal line clip selection transistor 147 is provided. In this regard, during P phase VSL settling (K12), the signal line clip voltage Vb transitions from a voltage Vb1 to a voltage Vb2 based on the switching operation of the selector 150, and is applied to the gate of the signal line clip transistor 146 (t12). Furthermore, the signal line clip voltage Vb transitions from the voltage Vb2 to the voltage Vb1 based on the switching operation of the selector 150, and is applied to the gate of the signal line clip transistor 146 (t14). The voltage Vb1 is set to turn off the signal line clip transistor 146. The voltage Vb2 is set such that the potential VSL of the vertical signal line 132 clipped via the signal line clip transistor 146 matches with the clip level Vcp.

As described above, in the above-described fifth embodiment, the signal line clip transistor 146 clips the potential VSL of the vertical signal line 132 and selects the vertical signal line 132. Consequently, it is possible to omit the signal line clip selection transistor 147, and simplify the circuit configuration.

### 6. Sixth Embodiment

In the above-described first embodiment, the signal line clip transistor 146 is electrically connected via the signal line clip selection transistor 147 connected to the vertical signal line 132. In this sixth embodiment, an amplifier transistor of the OB pixel is used as the signal line clip transistor 146, and a selection transistor of the OB pixel is used as the signal line clip selection transistor 147.

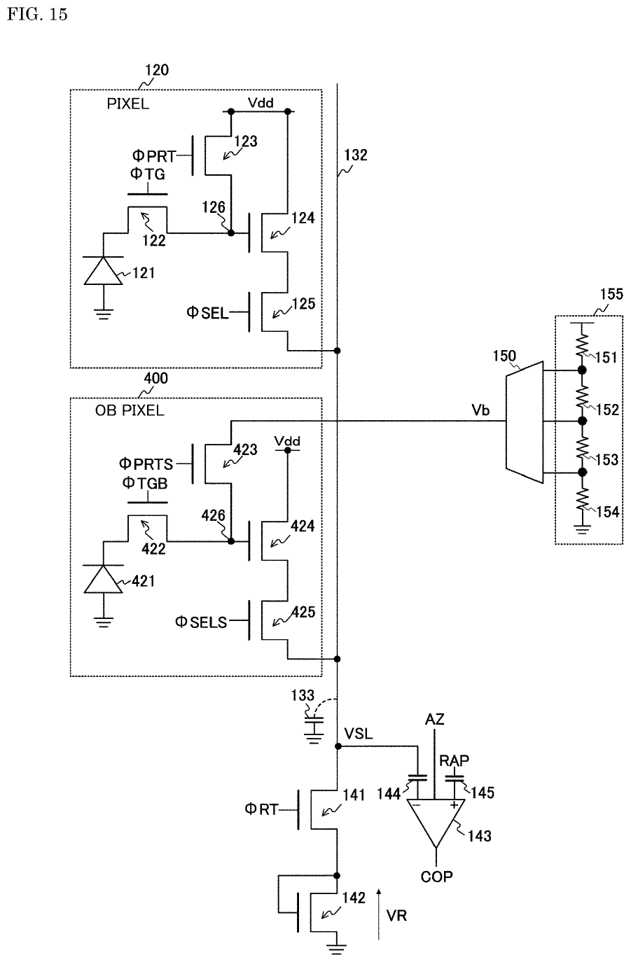

FIG. 15 is a diagram illustrating a configuration example of the signal readout circuit for one column according to the sixth embodiment.

In FIG. 15, this signal readout circuit is provided with an OB pixel 400 instead of the signal line clip transistor 146 and the signal line clip selection transistor 147 according to the above-described first embodiment. Components other than the signal readout circuit according to the fourth embodiment are the same as the components of the signal readout circuit according to the above-described first embodiment.

The OB pixel 400 includes a photodiode 421, a transfer transistor 422, a reset transistor 423, an amplifier transistor 424, a selection transistor 425, and a floating diffusion 426. The photodiode 421 is covered with a light shielding film.

The amplifier transistor 424 and the selection transistor 425 are connected in series. A cathode of the photodiode 421 is connected to the floating diffusion 426 via the transfer transistor 422. Furthermore, the power supply Vdd is connected to the vertical signal line 132 via the series circuit of the amplifier transistor 424 and the selection transistor 425. A gate of the amplifier transistor 424 is connected to the floating diffusion 426.

A gate of the transfer transistor 422 is applied a transfer signal ΦTGB. A gate of the reset transistor 423 is applied a pixel reset signal ΦPRTS. A drain of the reset transistor 423 is applied the signal line clip voltage Vb. A gate of the selection transistor 425 is applied a selection signal ΦSELS. The transfer signal ΦTGB, the pixel reset signal ΦPRTS, and the selection signal ΦSELS can be sent to each OB pixel 400 via the horizontal drive line 131 in FIG. 2.

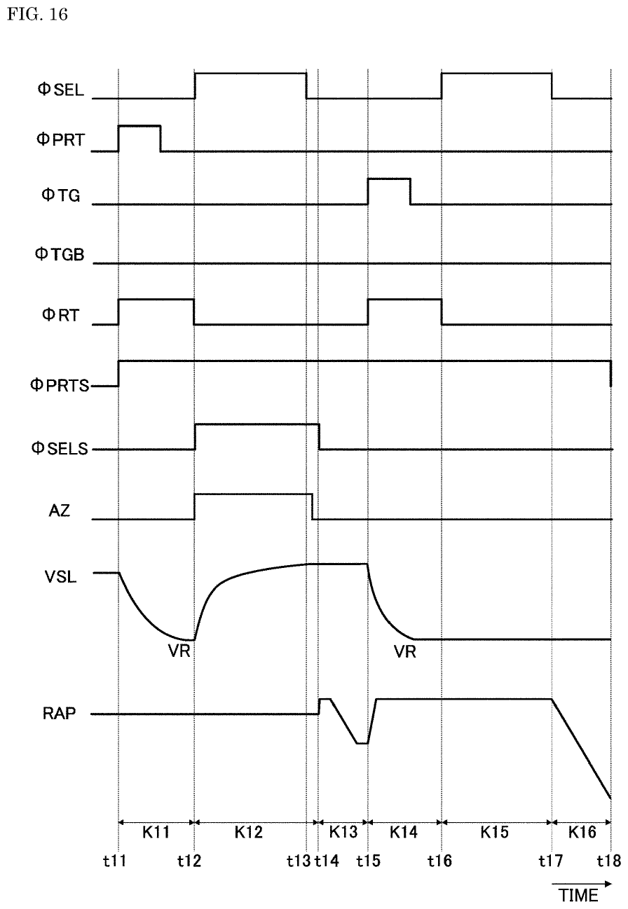

FIG. 16 is a diagram illustrating an example of a waveform of each unit at a time when the signal readout circuit reads out a constant current according to the sixth embodiment. Note that FIG. 16 illustrates the waveform of each unit at the time of readout of a signal when high brightness light such as sunlight is incident on the pixel 120.

In FIG. 16, a signal is read out from the pixel 120. In this case, the amplifier transistor 424 of the OB pixel 400 is used as the signal line clip transistor 146, and the selection transistor 425 of the OB pixel 400 is used as the signal line clip selection transistor 147. A capacitive load readout operation in this case is the same as a capacitive load readout operation in FIG. 7. In this regard, the amplifier transistor 424 of the OB pixel 400 is used as the signal line clip transistor 146, and the signal line clip voltage Vb is applied to the gate of the amplifier transistor 424. At this time, the pixel reset signal ΦPRTS is set to a high level (t11 to t18), and the reset transistor 423 is turned on. Furthermore, the transfer signal ΦTGB is set to a low level (t11 to t18), and the transfer transistor 422 is turned off.

Furthermore, during P phase VSL settling (K12), the signal line reset signal ΦRT falls, the selection signal ΦSELS rises (t12), and the selection transistor 425 is turned on. Furthermore, the output of the resistance ladder circuit 155 is selected such that the signal line clip voltage Vb becomes lower than the reset level of the pixel 120, and the signal line clip voltage Vb is applied to the gate of the amplifier transistor 424. Furthermore, the auto-zero signal AZ rises (t12) and the auto-zero operation of the comparator 143 is activated. Furthermore, after the auto-zero signal AZ falls, the selection signal ΦSELS falls (t14). At this time, the potential VSL of the vertical signal line 132 is clipped to the clip level Vcp, and is adjusted such that the non-inverting input and the inverting input of the comparator 143 balance when the potential VSL of the vertical signal line 132 is clipped.

On the other hand, a signal is read out from the OB pixel 400. In this case, the transfer transistor 422, the reset transistor 423, the amplifier transistor 424, and the selection transistor 425 of the OB 400 are caused to operate similarly to the transfer transistor 122, the reset transistor 123, the amplifier transistor 124, and the selection transistor 125 of the pixel 120. Furthermore, the output of the resistance ladder circuit 155 is selected such that the signal line clip voltage Vb is supplied as the power supply Vdd is applied to the drain of the reset transistor 423. In this case, the OB pixel 400 is shielded from light, and the light is not incident thereon, so that it is unnecessary to clip the vertical signal line 132 during P phase VLS settling.

As described above, in the above-described sixth embodiment, the amplifier transistor 424 of the OB pixel 400 is used as the signal line clip transistor 146, and the selection transistor 425 of the OB pixel 400 is used as the signal line clip selection transistor 147. Consequently, it is not necessary to provide the signal line clip transistor 146 and the signal line clip selection transistor 147 separately from the OB pixel 400 to prevent the sunspot phenomenon, so that it is possible to simplify the circuit configuration.

### 7. Seventh Embodiment

In the above-described first embodiment, the diode connection transistor 142 is connected via the signal line reset transistor 141 electrically connected to the vertical signal line 132 to set the reset level of the vertical signal line 132. In this seventh embodiment, the resistance ladder circuit 155 is used to set the clip level Vcp of the vertical signal line 132, and is used to set the reset level of the vertical signal line 132.

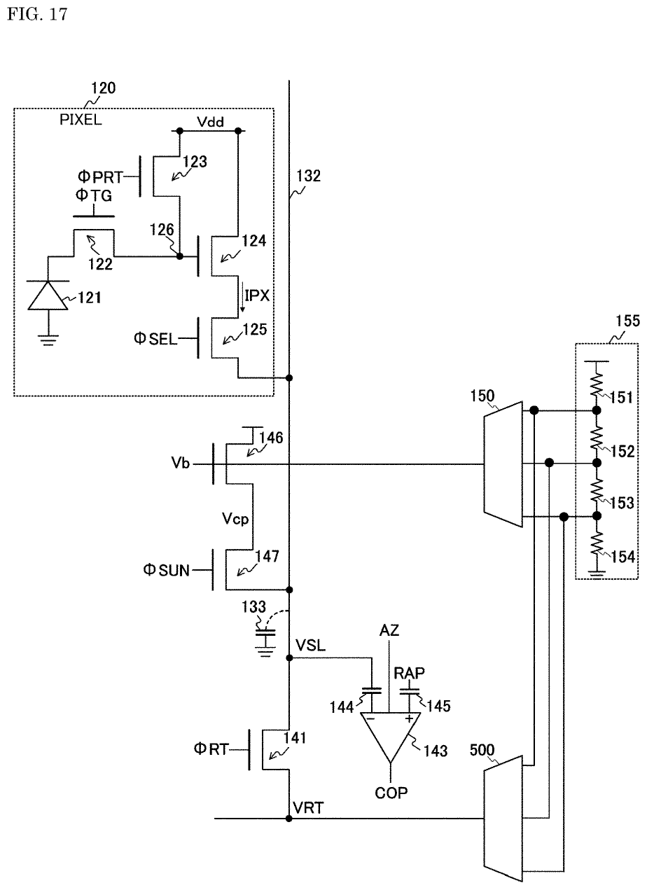

FIG. 17 is a diagram illustrating a configuration example of the signal readout circuit for one column according to the seventh embodiment.

In FIG. 17, this signal readout circuit is provided with a selector 500 instead of the diode connection transistor 142 according to the above-described first embodiment. Other components of the signal readout circuit according to the seventh embodiment are the same as the components of the signal readout circuit according to the above-described first embodiment.

The selector 500 switches divided voltages generated by the voltage divider resistances 151 to 154, and applies the divided voltage as a reset voltage VRT to the source of the signal line reset transistor 141. The reset voltage VRT can be set to a voltage larger than 0 V. Switching of the selector 500 can be controlled separately from switching of the selector 150.

As described above, in the above-described seventh embodiment, the resistance ladder circuit 155 is used to set the clip level Vcp of the vertical signal line 132, and is used to set the reset voltage VRT of the vertical signal line 132.

Consequently, it is possible to switch the reset voltage VRT of the vertical signal line 132 while suppressing an increase in a circuit scale.

### 8. Eighth Embodiment

In the above-described first embodiment, while the potential VSL of the vertical signal line 132 is clipped during P phase VSL settling, a signal read out from the pixel 120 is detected based on the potential VSL of the vertical signal line 132.

In this eighth embodiment, while a potential of a vertical signal line is clipped during P phase VSL settling, edge detection is performed based on a comparison result of the potential of the vertical signal line that is based on readout of load capacitances from different columns.

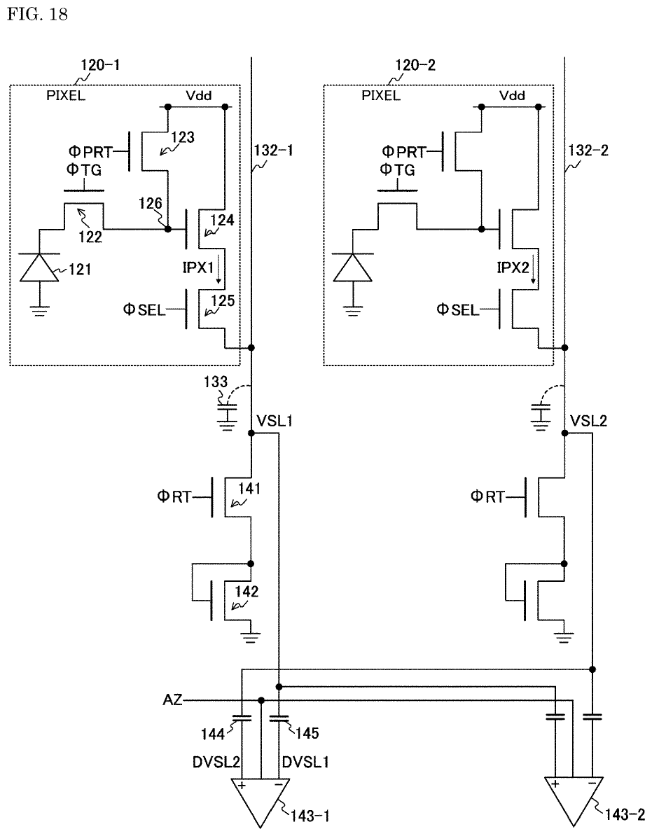

FIG. 18 is a diagram illustrating a configuration example of the signal readout circuit for two columns according to the eighth embodiment.

In FIG. 18, this signal readout circuit includes a plurality of vertical signal lines 132-1 and 132-2, and includes comparators 143-1 and 143-2 instead of the comparator 143 according to the above-described first embodiment. Other components of the signal readout circuit according to the eighth embodiment are the same as the components of the signal readout circuit according to the above-described first embodiment, and may include the signal line clip transistor 146 and the signal line clip selection transistor 147 although not illustrated.

The vertical signal lines 132-1 and 132-2 are connected with pixels 120-1 and 120-2, respectively, and the comparators 143-1 and 143-2 are connected with both of the vertical signal lines 132-1 and 132-2.

Each of the pixels 120-1 and 120-2 can be configured similarly to the pixel 120 in FIG. 6. The pixels 120-1 and 120-2 are connected with the vertical signal lines 132-1 and 132-2, respectively. Furthermore, each of the vertical signal lines 132-1 and 132-2 is connected with the diode connection transistor 142 via the signal line reset transistor 141.

Each of the comparators 143-1 and 143-2 detects a difference between comparator inputs DVSL1 and DVSL2. In this case, potentials VLS1 and VLS2 of the vertical signal lines 132-1 and 132-2 are output through the DC cut capacitors 144 and 145, and the comparator inputs DVSL1 and DVSL2 are generated. Furthermore, when the difference between the comparator inputs DVSL1 and DVSL2 is a threshold or more after auto-zero of the comparators 143-1 and 143-2, it is possible to determine that there is an edge.

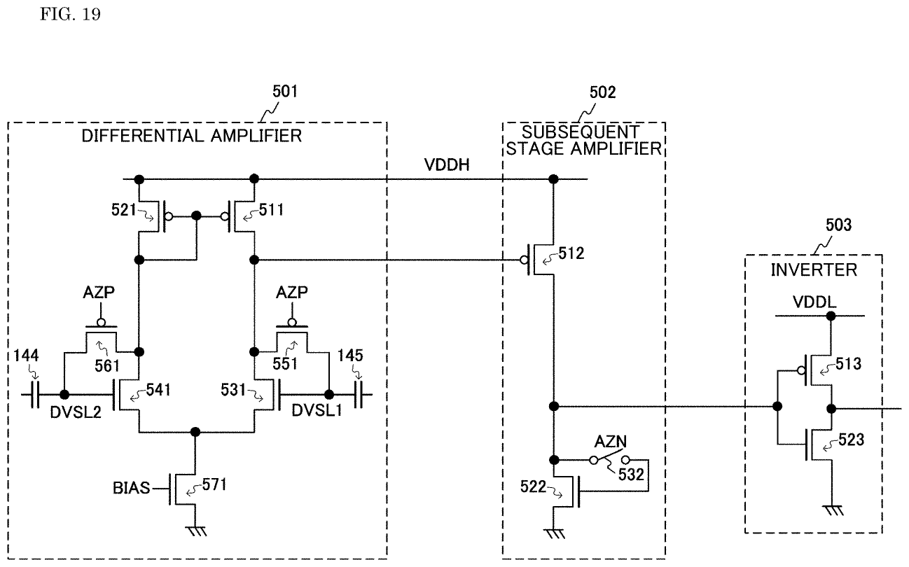

FIG. 19 is a diagram illustrating a configuration example of a comparator that is applied to the signal readout circuit according to the eighth embodiment. Note that, although a configuration of the comparator 143-1 in FIG. 18 is taken as an example in the following description, the comparator 143-2 can be also configured likewise.

In FIG. 19, the comparator 143-1 includes a differential amplifier 501, a subsequent stage amplifier 502, and an inverter 503. The subsequent stage amplifier 502 is connected to a subsequent stage of the differential amplifier 501, and the inverter 503 is connected to a subsequent stage of the subsequent stage amplifier 502.

The differential amplifier 501 balances the comparator inputs DVSL1 and DVSL2 based on the auto-zero operation, and then outputs a voltage corresponding to the difference between the comparator inputs DVSL1 and DVSL2. The differential amplifier 501 includes PMOS transistors 511, 521, 551, and 561 and NMOS transistors 531, 541, and 571.

The PMOS transistor 511 and the NMOS transistor 531 are connected in series with each other. The PMOS transistor 521 and the NMOS transistor 541 are connected in series with each other. Sources of the PMOS transistors 511 and 521 are connected to a power supply voltage VDDH, and gates of the PMOS transistors 511 and 521 are connected to a drain of the PMOS transistor 521. In this case, the PMOS transistors 511 and 521 can constitute a current mirror.

The PMOS transistor 551 is connected between a gate and a drain of the NMOS transistor 531, and the PMOS transistor 561 is connected between a gate and a drain of the NMOS transistor 541. The sources of the NMOS transistor 531 and 541 are grounded via the NMOS transistor 571.

Gates of the PMOS transistors 551 and 561 are applied an auto-zero signal AZP, and a gate of the NMOS transistor 571 is applied a bias voltage BIAS. The NMOS transistor 571 can operate as a constant current source based on the bias voltage BIAS.

The subsequent stage amplifier 502 amplifies an output of the differential amplifier 501. The subsequent stage amplifier 502 includes a PMOS transistor 512, an NMOS transistor 522, and a switch 532.

The PMOS transistor 512 and the NMOS transistor 522 are connected in series with each other. A source of the PMOS transistors 512 is connected to the power supply voltage VDDH, and a gate of the PMOS transistor 512 is connected to a drain of the PMOS transistor 511. A switch 532 is connected between a gate and a drain of an NMOS transistor 522, and a source of the NMOS transistor 522 is grounded. The switch 532 opens and closes based on an auto-zero signal AZN.

The inverter 503 converts an output of the subsequent stage amplifier 502 into a logical value ‘0’ or a logical value ‘1’. The inverter 503 includes a PMOS transistor 513 and an NMOS transistor 523.

The PMOS transistor 513 and the NMOS transistor 523 are connected in series with each other. A source of the PMOS transistor 513 is connected to a power supply voltage VDDL, and a source of the NMOS transistor 523 is grounded.

The power supply voltage VDDL can be made lower than the power supply voltage VDDH. A gate of the PMOS transistors 513 and a gate of the NMOS transistor 523 are connected to a drain of the PMOS transistor 512.

In the auto-zero period, the PMOS transistors 551 and 561 are turned on based on the auto-zero signal AZP, and the switch 532 is closed based on the auto-zero signal AZN. Note that a timing at which the PMOS transistors 551 and 561 are turned off after being turned on can be set to a timing after a timing at which the switch 532 is opened after being closed. In this case, the current flows to the PMOS transistors 551 and 561 based on current mirror operations of the PMOS transistors 511 and 521. Furthermore, the charge is stored in each of the DC cut capacitors 144 and 145 such that a non-inverting input and an inverting input of the comparator 143-1 balance.

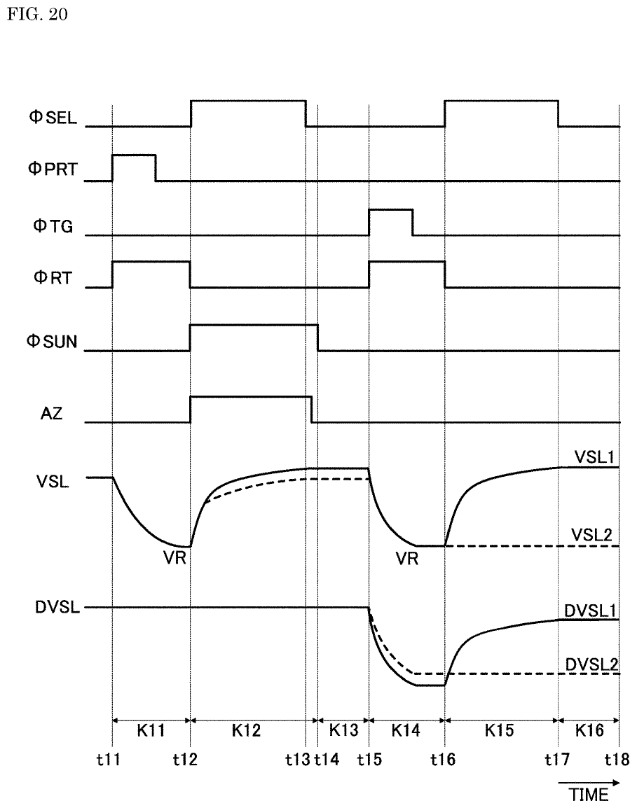

FIG. 20 is a diagram illustrating an example of a waveform of each unit at a time when the imaging device according to the eighth embodiment reads out a signal. Note that FIG. 20 assumes that normal light is incident on the pixel 120-1 and high brightness light such as sunlight is incident on the pixel 120-2.

In FIG. 20, a capacitive load readout operation is the same as that in FIG. 8 in a case of the pixel 120-1, and is the same as that in FIG. 7 in a case of the pixel 120-2. In this case, even when the high brightness light is incident on the pixel 120-2, the potential VSL2 of the vertical signal line 132-2 is clipped during P phase VSL settling (K12), the potential VSL2 of the vertical signal line 132-2 is raised to a potential equal to the potential VSL1 of the vertical signal line 132-1. Hence, the difference between the comparator inputs DVSL1 and DVSL2 corresponding to a difference between the potentials VSL1 and VSL2 of the vertical signal lines 132-1 and 132-2 during D phase VSL settling is substantially maintained, and edge erroneous determination is prevented.

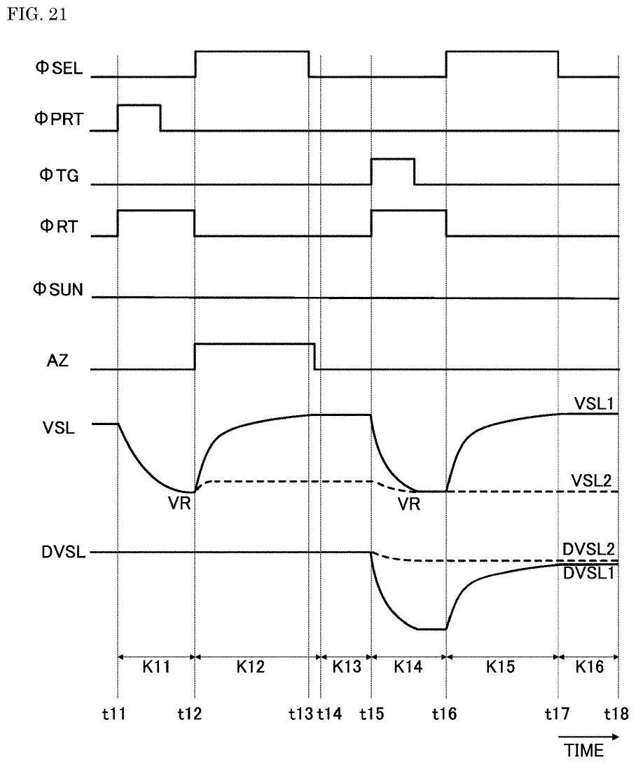

FIG. 21 is a diagram illustrating an example of a waveform of each unit at a time when the imaging device reads out a signal according to a comparative example of the eighth embodiment. Note that this comparative example assumes that the vertical signal line 132-2 is not clipped during P phase VSL settling. Furthermore, FIG. 21 assumes that normal light is incident on the pixel 120-1 and high brightness light such as sunlight is incident on the pixel 120-2.

In FIG. 21, the capacitive load readout operation is the same as that in FIG. 8 in a case of the pixel 120-1, and is the same as that in FIG. 7 in a case of the pixel 120-2. In this regard, the signal line clip selection signal ΦSUN at the time of P phase VSL settling (K12) is maintained at a low level. In this case, the potential VSL2 of the vertical signal line 132-2 is not clipped, and therefore when the normal light is incident on the pixel 120-1 and the high brightness light is incident on the pixel 120-2, the potentials VSL1 and VSL2 of the vertical signal lines 132-1 and 132-2 are opened at the time of P phase VSL settling. Hence, the difference between the potentials VSL1 and VSL2 of the vertical signal lines 132-1 and 132-2 during D phase VSL settling is not reflected in the difference between the comparator inputs DVSL1 and DVSL2, which causes edge erroneous determination.

As described above, in the above-described eighth embodiment, while the potentials VLS1 and VLS2 of the vertical signal lines 132-1 and 132-2 during P phase VSL settling are clipped, the difference between the comparators inputs DVSL1 and DVSL2 is detected after auto-zero of the comparators 143-1 and 143-2. Consequently, even when high brightness light such as sunlight is incident on the pixel 120-2, it is possible to detect an edge of a subject while reducing an influence of fixed pattern noise.

### 9. Ninth Embodiment

In the above-described first embodiment, the clipping operation of the potential VLS of the vertical signal line 132 is applied to read out the capacitive load from the pixel 120 provided with the one photodiode 121 for the one amplifier transistor 124. In this ninth embodiment, the clipping operation of the potential VLS of the vertical signal line 132 is applied to read out the capacitive load from a cell provided with four photodiodes for the one amplifier transistor 124.

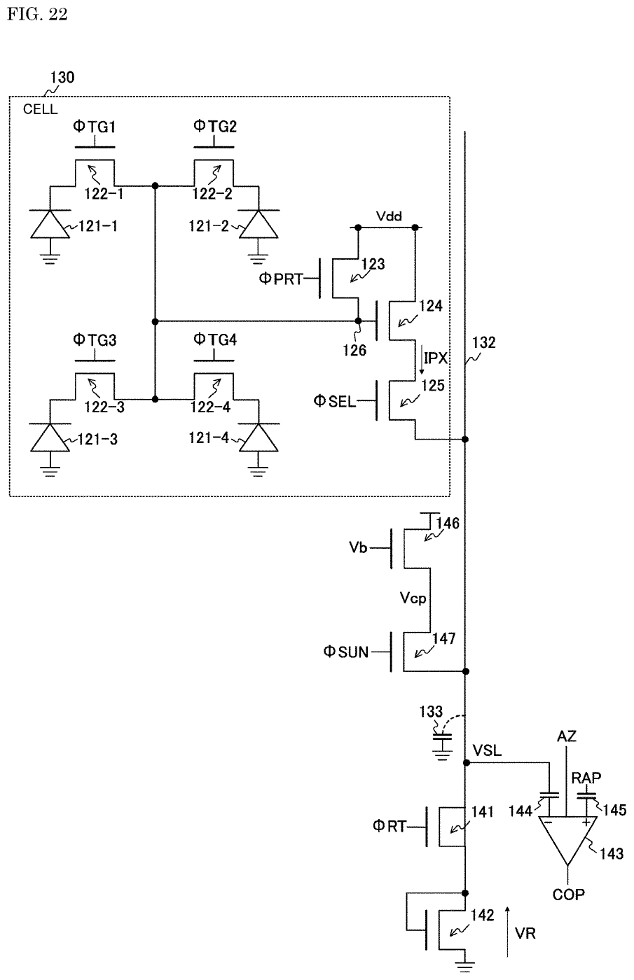

FIG. 22 is a diagram illustrating a configuration example of the signal readout circuit for one column according to the ninth embodiment.

In FIG. 22, this signal readout circuit is provided with a cell 130 instead of the pixel 120 of the signal readout circuit according to the above-described first embodiment. Other components of the signal readout circuit according to the ninth embodiment are the same as the components of the signal readout circuit according to the above-described first embodiment.

The cell 130 includes photodiodes 121-1 to 121-4 and transfer transistors 122-1 to 122-4 instead of the photodiode 121 and the transfer transistor 122 according to the above-described first embodiment. Other components of the cell 130 according to the ninth embodiment are the same as the components of the pixel 120 according to the above-described first embodiment.

The photodiodes 121-1 to 121-4 can be disposed in two rows x two columns. Each of the photodiodes 121-1 to 121-4 is connected to the floating diffusion 126 via each of the transfer transistors 122-1 to 122-4. Gates of the transfer transistors 122-1 to 122-4 are applied transfer signals ΦTG1 to ΦTG4. By controlling application timings of these transfer signals ΦTG1 to ΦTG4, it is possible to individually read out signals from each of the photodiodes 121-1 to 121-4 to the vertical signal line 132. An operation of reading out a capacitive load from each of the photodiodes 121-1 to 121-4 is the same as that in FIG. 7 or 8.

As described above, in the above-described ninth embodiment, the clipping operation of the potential VLS of the vertical signal line 132 is applied to read out the capacitive load from the cell 130 provided with the four photodiodes 121-1 to 121-4 for the one amplifier transistor 124. Consequently, it is possible to prevent an increase in the number of pixels while suppressing an increase in a pixel region, and apply readout of a capacitive load per pixel while preventing the sunspot phenomenon.

Note that, although the above-described ninth embodiment has described the example where the four photodiodes 121-1 to 121-4 are shared for the one amplifier transistor 124, eight photodiodes may be shared for the one amplifier transistor 124. Furthermore, any configuration according to the above-described second embodiment to eighth embodiment may be applied to the configuration provided with the cell 130.

### 10. Tenth Embodiment

In the above-described first embodiment, the clipping operation of the potential VLS of the vertical signal line 132 is applied to read out the capacitive load from each pixel 120 connected to the vertical signal line 132. In this tenth embodiment, the clipping operation of the potential VLS of the vertical signal line 132 is applied to a binning operation that is based on readout of the capacitive load from the pixel 120 connected to the vertical signal line 132.

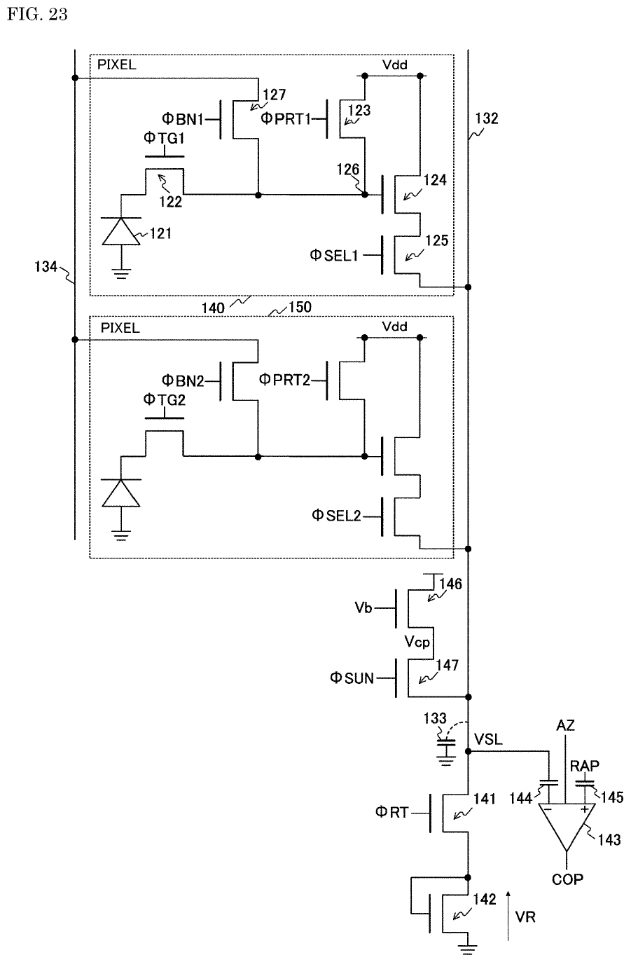

FIG. 23 is a diagram illustrating a configuration example of the signal readout circuit for one column according to the tenth embodiment.

In FIG. 23, this signal readout circuit is provided with pixels 140 and 150 instead of the pixel 120 of the signal readout circuit according to the above-described first embodiment. Furthermore, this signal readout circuit additionally includes a binning line 134 in the signal readout circuit according to the above-described first embodiment. Other components of the signal readout circuit according to the tenth embodiment are the same as the components of the signal readout circuit according to the above-described first embodiment.

Each of the pixels 140 and 150 additionally includes a binning transistor 127 in the pixel 120 according to the above-described first embodiment. Other components of each the pixels 140 and 150 according to the tenth embodiment are the same as the components of the pixel 120 according to the above-described first embodiment.

The binning transistor 127 is connected between the floating diffusion 126 and the binning line 134 per pixel 140 and 150. The binning transistor 127 may be a MOS transistor. A gate of the binning transistor 127 is applied binning signals ΦBN1 and ΦBN2 per pixel 140 and 150. The gate of the transfer transistor 122 is applied transfer signals ΦTG1 and ΦTG2 per pixel 140 and 150. The gate of the reset transistor 123 is applied pixel reset signals ΦPRT1 and ΦPRT2 per pixel 140 and 150. The gate of the selection transistor 125 is applied selection signals ΦSEL1 and ΦSEL2 per pixel 140 and 150.

When a signal is individually read out from each of the pixels 140 and 150, the binning signals ΦBN1 and ΦBN2 are set to low levels, and the binning transistor 127 of each of the pixels 140 and 150 is turned off. When the signal from each of the pixels 140 and 150 is subjected to binning readout, the binning signals ΦBN1 and ΦBN2 are set to high levels, and the binning transistor 127 of each of the pixels 140 and 150 is turned off. An operation of reading out a capacitive load from each of the pixels 140 and 150 is the same as that in FIG. 7. In this case, at a time of binning readout, one of the selection transistors 125 of the pixels 140 and 150 may be turned on, or both of the selection transistors 125 of the pixels 140 and 150 may be turned on.

As described above, in the above-described tenth embodiment, the binning transistors 127 are provided to the pixels 140 and 150 connected to the vertical signal line 132. Consequently, it is possible to apply readout of the capacitive load and reduce power consumption while reducing the number of times of readout of each frame.

Note that any configuration according to the above-described second embodiment to ninth embodiment may be applied to the configuration provided with the pixels 140 and 150.

### 11. Eleventh Embodiment

In the above-described first embodiment, the signal line clip transistor 146 is electrically connected via the signal line clip selection transistor 147 connected to the vertical signal line 132 that sends a signal read out from the pixel 120. In this twelfth embodiment, substrates on each of which a solid-state imaging device provided with a pixel array unit including the pixels 120 aligned in the matrix has been formed are stacked.

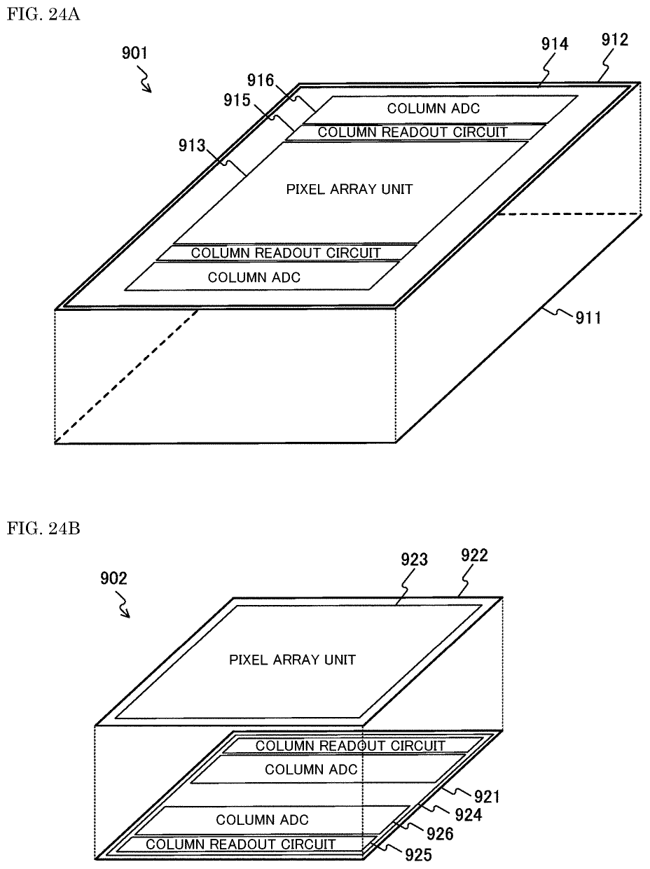

FIG. 24 is a perspective view illustrating a configuration example of the imaging device according to the eleventh embodiment.

In a of FIG. 24, a solid-state imaging device 901 includes a support substrate 911 and a semiconductor substrate 912. The semiconductor substrate 912 is stacked on the support substrate 911. The semiconductor substrate 912 includes a pixel array unit 913 and a peripheral circuit 914. In the peripheral circuit 914, a column readout circuit 915 and a column ADC 916 are formed. The column readout circuit 915 and the column ADC 916 may be formed on both sides in the column direction of the pixel array unit 913.

In the pixel array unit 913, the pixels 120 are aligned in the matrix along the row direction and the column direction. The column readout circuit 915 can clip a potential of a vertical signal line during D phase VSL settling, and read out the signal from each pixel 120 based on readout of a capacitive load. In the column readout circuit 915, for example, the signal line reset transistor 141, the diode connection transistor 142, the signal line clip transistor 146, and the signal line clip selection transistor 147 in FIG. 6 may be formed. The column ADC 916 can perform AD conversion on the signal read out via the column readout circuit 915 per column. In this case, the solid-state imaging device 901 can be configured as a back-illuminated type image sensor.

In b of FIG. 24, a solid-state imaging device 902 includes semiconductor substrates 921 and 922. The semiconductor substrate 922 is stacked on the semiconductor substrate 921. On the semiconductor substrate 922, a pixel array unit 923 is formed. On the semiconductor substrate 922, a peripheral circuit 924 is formed. In the peripheral circuit 924, a column readout circuit 925 and a column ADC 926 are formed. The column readout circuit 925 and the column ADC 926 may be formed to meet positions on both sides in the column direction of the pixel array unit 923. In this case, the solid-state imaging device 902 can be configured as a back-illuminated type image sensor.

As described above, in the above-described twelfth embodiment, substrates on each of which each of the solid-state imaging devices 901 and 902 is formed are stacked. Consequently, it is possible to thin the semiconductor substrates 912 and 922 on which each of the pixel array units 913 and 923 is formed while supporting each of the pixel array units 913 and 923, and form the back-illuminated type image sensor.

### 12. Example of Application to Moving Body

The technology according to the present disclosure (the present technology) can be applied to various products. For example, the technology according to the present disclosure may be realized as a device equipped in any type of a moving body such as an automobile, an electric vehicle, a hybrid electric vehicle, a motorcycle, a bicycle, a personal mobility device, an airplane, a drone, a ship, and a robot.

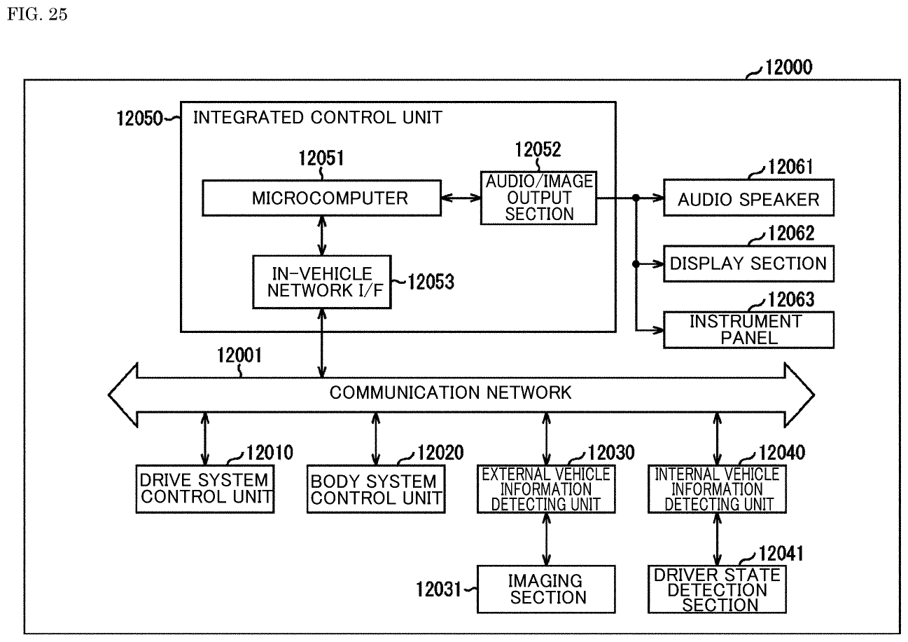

FIG. 25 is a block diagram illustrating a schematic configuration example of a vehicle control system that is an example of a moving body control system to which the technology of the present disclosure can be applied.

The vehicle control system 12000 includes a plurality of electronic control units connected thereto via a communication network 12001. In the example illustrated in FIG. 25, the vehicle control system 12000 includes a drive system control unit 12010, a body system control unit 12020, an external vehicle information detecting unit 12030, an internal vehicle information detecting unit 12040, and an integrated control unit 12050. Furthermore, as a functional configuration of the integrated control unit 12050, a microcomputer 12051, an audio/image output section 12052, and an in-vehicle network interface (I/F) 12053 are illustrated.

The drive system control unit 12010 controls an operation of a device related to a drive system of a vehicle according to various programs. For example, the drive system control unit 12010 functions as a driving force generation device for generating a driving force of a vehicle such as an internal combustion engine or a driving motor, a driving force transmission mechanism for transmitting a driving force to wheels, a steering mechanism for adjusting a turning angle of a vehicle, and a control device such as a braking device that generates a braking force of a vehicle.

The body system control unit 12020 controls operations of various devices mounted in the vehicle body according to various programs. For example, the body system control unit 12020 functions as a control device of a keyless entry system, a smart key system, a power window device, or various lamps such as a headlamp, a back lamp, a brake lamp, a turn signal, and a fog lamp. In this case, radio waves transmitted from a portable device that substitutes for a key or signals of various switches may be input to the body system control unit 12020. The body system control unit 12020 receives inputs of the radio waves or signals and controls a door lock device, a power window device, and a lamp of the vehicle. The external vehicle information detecting unit 12030 detects information on the outside of the vehicle having the vehicle control system 12000 mounted thereon. For example, an imaging section 12031 is connected to the external vehicle information detecting unit 12030. The external vehicle information detecting unit 12030 causes the imaging section 12031 to capture an image of the outside of the vehicle and receives the captured image. The external vehicle information detecting unit 12030 may perform object detection processing or distance detection processing for peoples, cars, obstacles, signs, and letters on the road based on the received image.

The imaging section 12031 is an optical sensor that receives light and outputs an electrical signal according to the amount of the received light. The imaging section 12031 can also output the electrical signal as an image or distance measurement information. Furthermore, the light received by the imaging section 12031 may be visible light or may be invisible light such as infrared light.

The internal vehicle information detecting unit 12040 detects information on the inside of the vehicle. For example, a driver state detecting section 12041 that detects a driver's state is connected to the internal vehicle information detecting unit 12040. The driver state detecting section 12041 includes, for example, a camera that captures an image of a driver, and the internal vehicle information detecting unit 12040 may calculate a degree of fatigue or concentration of the driver or may determine whether or not the driver is dozing based on detection information input from the driver state detecting section 12041.

The microcomputer 12051 can calculate a control target value for the driving force generation device, the steering mechanism, or the braking device based on the information regarding the inside and outside of the vehicle that is acquired by the external vehicle information detecting unit 12030 or the internal vehicle information detecting unit 12040, and can output a control command to the drive system control unit 12010. For example, the microcomputer 12051 can perform cooperative control for the purpose of implementing the functions of an Advanced Driver Assistance System (ADAS) including vehicle collision avoidance or impact mitigation, following traveling based on an inter-vehicle distance, vehicle speed maintenance traveling, a vehicle collision warning, a vehicle lane departure warning, and the like.

Further, the microcomputer 12051 can perform cooperative control for the purpose of automated driving or the like in which autonomous travel is performed without depending on operations of the driver, by controlling the driving force generation device, the steering mechanism, the braking device, or the like based on information about the surroundings of the vehicle acquired by the external vehicle information detecting unit 12030 or the internal vehicle information detecting unit 12040.

Furthermore, the microcomputer 12051 can output a control command to the body system control unit 12020 based on the information acquired by the external vehicle information detecting unit 12030 outside the vehicle. For example, the microcomputer 12051 can perform cooperative control for the purpose of preventing glare, such as switching from a high beam to a low beam, by controlling the headlamp according to the position of a preceding vehicle or an oncoming vehicle detected by the external vehicle information detecting unit 12030.

The audio/image output section 12052 transmits an output signal of at least one of an audio and an image to an output device capable of visually or audibly notifying a passenger or the outside of the vehicle of information. In the example in FIG. 25, an audio speaker 12061, a display section 12062, and an instrument panel 12063 are illustrated as examples of the output device. The display section 12062 may include at least one of an on-board display and a head-up display, for example.

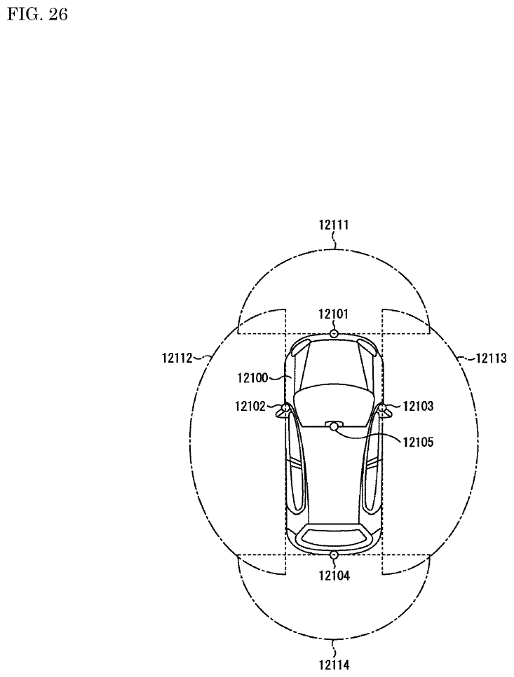

FIG. 26 is a diagram illustrating an example of an installation position of the imaging section 12031.

In FIG. 26, imaging sections 12101, 12102, 12103, 12104, and 12105 are provided as the imaging section 12031.

The imaging sections 12101, 12102, 12103, 12104, and 12105 are provided at positions such as a front nose, side-view mirrors, a rear bumper, a back door, and an upper portion of a windshield in a vehicle interior of the vehicle 12100, for example. The imaging section 12101 provided on the front nose and the imaging section 12105 provided in the upper portion of the windshield in the vehicle interior mainly acquire images of the front of the vehicle 12100. The imaging sections 12102 and 12103 provided on the side-view mirrors mainly acquire images of a lateral side of the vehicle 12100. The imaging section 12104 provided on the rear bumper or the back door mainly acquires images of the rear of the vehicle 12100. The imaging section 12105 provided on an upper part of the windshield in the vehicle interior is mainly used for detecting preceding vehicles, pedestrians, obstacles, traffic signals, traffic signs, lanes, and the like.

Note that FIG. 26 illustrates an example of imaging ranges of the imaging sections 12101 to 12104. An imaging range 12111 indicates an imaging range of the imaging section 12101 provided at the front nose, imaging ranges 12112 and 12113 respectively indicate the imaging ranges of the imaging sections 12102 and 12103 provided at the side-view mirrors, and an imaging range 12114 indicates the imaging range of the imaging section 12104 provided at the rear bumper or the back door. For example, by superimposing image data captured by the imaging sections 12101 to 12104, it is possible to obtain a bird's eye view image viewed from the upper side of the vehicle 12100.

At least one of the imaging sections 12101 to 12104 may have a function of acquiring distance information. For example, at least one of the imaging sections 12101 to 12104 may be a stereo camera constituted by a plurality of imaging elements or may be an imaging element that has pixels for phase difference detection.

For example, the microcomputer 12051 can extract as a preceding vehicle a three-dimensional object that is the closest three-dimensional object on a traveling path of the vehicle 12100 in particular and is traveling at a predetermined speed (e.g., 0 km/h or higher) in the substantially same direction as that of the vehicle 12100 by acquiring a distance to each three-dimensional object in the imaging ranges 12111 to 12114 and a temporal change of this distance (a relative speed with respect to the vehicle 12100) based on the distance information obtained from the imaging sections 12101 to 12104. Furthermore, the microcomputer 12051 can set an inter-vehicle distance to be secured from a preceding vehicle in advance with respect to the preceding vehicle and can perform automated brake control (also including following stop control) or automated acceleration control (also including following start control). In this way, cooperative control can be performed for the purpose of automated traveling or the like in which a vehicle automatedly travels without the operations of the driver.

For example, the microcomputer 12051 can classify and extract three-dimensional data regarding three-dimensional objects into two-wheeled vehicles, normal vehicles, large vehicles, pedestrians, and other three-dimensional objects such as electric poles based on distance information obtained from the imaging sections 12101 to 12104 and can use the three-dimensional data to perform automated avoidance of obstacles. For example, the microcomputer 12051 differentiates surrounding obstacles of the vehicle 12100 into obstacles that can be viewed by the driver of the vehicle 12100 and obstacles that are difficult to view. Furthermore, the microcomputer 12051 determines a collision risk indicating the degree of risk of collision with each obstacle, and when the collision risk is equal to or higher than a set value and there is a possibility of collision, an alarm is output to the driver through the audio speaker 12061 or the display section 12062, forced deceleration or avoidance steering is performed through the drive system control unit 12010, and thus it is possible to perform driving support for collision avoidance.

At least one of the imaging sections 12101 to 12104 may be an infrared camera that detects infrared rays. For example, the microcomputer 12051 can recognize a pedestrian by determining whether or not there is a pedestrian in the captured image of the imaging sections 12101 to 12104. Such pedestrian recognition is performed by, for example, a procedure of extracting feature points in the captured images of the imaging sections 12101 to 12104 as infrared cameras and a procedure of performing pattern matching processing on a series of feature points indicating an outline of an object and determining whether or not the object is a pedestrian. When the microcomputer 12051 determines that there is a pedestrian in the captured images of the imaging sections 12101 to 12104 and the pedestrian is recognized, the audio/image output section 12052 controls the display section 12062 such that a square contour line for emphasis is superimposed and displayed on the recognized pedestrian. Furthermore, the audio/image output section 12052 may control the display section 12062 to display an icon or the like indicating a pedestrian at a desired position.

An example of the vehicle control system to which the technology according to the present disclosure can be applied has been described above. The technology according to the present disclosure can be applied to the imaging section 12031 within the above-described configuration. More specifically, for example, the above-described camera 100 can be applied to the imaging section 12031. By applying the technology according to the present disclosure to the vehicle control system 12000, it is possible to obtain captured images while suppressing an increase in power consumption.

Note that it should be noted that the above-described embodiments describe the examples for embodying the present technology, and matters in the embodiments and matters specifying the invention in the claims have a corresponding relationship with each other. Likewise, the matters specifying the invention in the claims correspond to the matters in the embodiments of the present technology that have the same names. However, the present technology is not limited to the embodiments and can be embodied by applying various modifications to the embodiments without departing from the gist thereof. Furthermore, the effects described in the description are merely exemplary and not intended to be limited, and other effects may be provided as well.

Note that the present technology can also have the following configurations.

(1) An imaging device includes:
a signal line whose potential changes based on a charge stored according to a current flowing at a time of readout of a signal from a pixel;
a signal line reset transistor that resets the potential of the signal line;
a signal line reset level generation unit that generates a reset level of the potential of the signal line;
a signal line clip transistor that clips the potential of the signal line; and
a signal line clip voltage setting unit that sets a signal line clip voltage used to generate a clip level of the potential of the signal line.

(2) In the imaging device described in above (1), the potential of the signal line is a potential a parasitic capacitance of the signal line.

(3) In the imaging device described in above (1) or (2), the pixel further includes
a photodiode,
a transfer transistor that transfers a charge stored in the photodiode to a floating diffusion,
a reset transistor that resets the floating diffusion,
an amplifier transistor that outputs a signal corresponding to the potential of the floating diffusion, and
a selection transistor that is connected between the amplifier transistor and the signal line.

(4) In the imaging device described in any one of above (1) to (3), the signal line reset level generation unit includes a diode connection transistor.

(5) The imaging device described in any one of above (1) to (4) further includes a driver that drives the signal line reset transistor.

(6) The imaging device described in any one of above (1) to (5) further includes a signal line clip selection transistor that is connected between the signal line and the signal line clip transistor.

(7) The imaging device described in above (6) further includes:
a first chip on which the pixel, the signal line clip transistor, and the signal line clip selection transistor have been formed, and
a second chip on which the first chip has been stacked, and the signal line reset transistor, the signal line reset level generation unit, and the signal line clip voltage setting unit have been formed.

(8) In the imaging device described in above (6) or (7),
a gate length and a gate width of the signal line clip selection transistor are equal to a gate length and a gate width of an amplifier transistor of the pixel, and
a gate length and a gate width of the signal line clip selection transistor are equal to a gate length and a gate width of a selection transistor of the pixel.

(9) In the imaging device described in any one of above (6) to (8), the signal line is simultaneously driven by the signal line clip selection transistor and an amplifier transistor of the pixel.

(10) The imaging device described in any one of above (6) to (9) further includes a comparator that compares the potential of the signal line and a ramp signal.

(11) The imaging device described in any one of above (6) to (9) further includes a comparator that compares potentials of signal lines provided to different columns.

(12) The imaging device described in any one of above (6) to (11) includes: a first DC cut capacitor that is connected to a first input terminal of the comparator;
a second DC cut capacitor that is connected to a second input terminal of the comparator; and
an auto-zero control unit that respectively controls charges stored in the first DC cut capacitor and the second DC cut capacitor such that a first input and a second input of the comparator during an auto-zero period balance.

(13) In the imaging device described in above (12), the signal line clip selection transistor is turned off after the auto-zero period.

(14) In the imaging device described in any one of above (1) to (13), the signal line clip voltage is lower than a reset level of the pixel.

(15) The imaging device described in any one of above (1) to (14) further includes a constant current transistor that can be electrically connected to the signal line, and causes a constant current to flow based on a source follower formed between the constant current transistor and the pixel.

(16) In the imaging device described in above (15),
the constant current transistor is turned on when the constant current is read out using the constant current transistor, and
the constant current transistor is turned off when a capacitive load is read out using the signal line reset level generation unit.

(17) In the imaging device described in any one of above (1) to (16), the signal line clip voltage setting unit generates a plurality of the clip levels.

(18) In the imaging device described in any one of above (1) to (17), the signal line clip voltage setting unit includes
a resistance ladder circuit, and
a first selector that switches a divided voltage generated by the resistance ladder circuit.

(19) In the imaging device described in above (18), the signal line reset level generation unit includes
a second selector that switches a divided voltage generated by the resistance ladder circuit.

(20) The imaging device described in any one of above (1) to (19) further includes
a pixel array unit in which the pixels are disposed in a matrix in a row direction and a column direction,
the signal line is provided per column, and
the signal line reset transistor and the signal line clip transistor are provided to each signal line.
100 Camera
101 Optical system
102 Solid-state imaging device
103 Imaging control unit
104 Image processing unit
105 Storage unit
106 Display unit
107 Operation unit
108 Bus
111 Pixel array unit
112 Vertical scanning circuit
113 Column readout circuit
114 Column signal processing unit
115 Horizontal scanning circuit
116 Control circuit
117 Signal line clip level setting circuit
121 Photodiode
122 Transfer transistor
123 Reset transistor
124 Amplifier transistor
125 Selection transistor
126 Floating diffusion
131 Horizontal drive line
132 Vertical signal line
133 Capacitance
141 Signal line reset transistor
142 Diode connection transistor
143 Comparator
144, 145 DC cut capacitor
146 Signal line clip transistor
147 signal line clip selection transistor
148 Auto-zero control unit
150 Selector
151 to 154 Voltage divider resistance
155 Resistance ladder circuit

What is claimed is:

1. An imaging device comprising:
a signal line whose potential changes based on a charge stored according to a current flowing at a time of readout of a signal from a pixel;
a signal line reset transistor that resets the potential of the signal line;
a signal line reset level generation unit that generates a reset level of the potential of the signal line;
a signal line clip transistor that clips the potential of the signal line; and
a signal line clip voltage setting unit that sets a signal line clip voltage used to generate a clip level of the potential of the signal line.

2. The imaging device according to claim 1, wherein the potential of the signal line is a potential a parasitic capacitance of the signal line.

3. The imaging device according to claim 1, wherein the pixel further includes
a photodiode,
a transfer transistor that transfers a charge stored in the photodiode to a floating diffusion,
a reset transistor that resets the floating diffusion, an amplifier transistor that outputs a signal corresponding to the potential of the floating diffusion, and
a selection transistor that is connected between the amplifier transistor and the signal line.

4. The imaging device according to claim 1, wherein the signal line reset level generation unit includes a diode connection transistor.

5. The imaging device according to claim 1, further comprising a driver that drives the signal line reset transistor.

6. The imaging device according to claim 1, further comprising a signal line clip selection transistor that is connected between the signal line and the signal line clip transistor.

7. The imaging device according to claim 6, further comprising:
a first chip on which the pixel, the signal line clip transistor, and the signal line selection transistor have been formed, and
a second chip on which the first chip has been stacked, and the signal line reset transistor, the signal line reset level generation unit, and the signal line clip voltage setting unit have been formed.

8. The imaging device according to claim 7, wherein
a gate length and a gate width of the signal line clip selection transistor are equal to a gate length and a gate width of an amplifier transistor of the pixel, and
a gate length and a gate width of the signal line clip selection transistor are equal to a gate length and a gate width of a selection transistor of the pixel.

9. The imaging device according to claim 7, wherein the signal line is simultaneously driven by the signal line clip selection transistor and an amplifier transistor of the pixel.

10. The imaging device according to claim 6, further comprising a comparator that compares the potential of the signal line and a ramp signal.

11. The imaging device according to claim 6, further comprising a comparator that compares potentials of signal lines provided to different columns.

12. The imaging device according to claim 10, further comprising:
a first DC cut capacitor that is connected to a first input terminal of the comparator;
a second DC cut capacitor that is connected to a second input terminal of the comparator; and
an auto-zero control unit that respectively controls charges stored in the first DC cut capacitor and the second DC cut capacitor such that a first input and a second input of the comparator during an auto-zero period balance.

13. The imaging device according to claim 12, wherein the signal line clip selection transistor is turned off after the auto-zero period.

14. The imaging device according to claim 1, wherein the signal line clip voltage is lower than a reset level of the pixel.

15. The imaging device according to claim 1, further comprising a constant current transistor that can be electrically connected to the signal line, and causes a constant current to flow based on a source follower formed between the constant current transistor and the pixel.

16. The imaging device according to claim 15, wherein
the constant current transistor is turned on when the constant current is read out using the constant current transistor, and
the constant current transistor is turned off when a capacitive load is read out using the signal line reset level generation unit.

17. The imaging device according to claim 1, wherein the signal line clip voltage setting unit generates a plurality of the clip levels.

18. The imaging device according to claim 1, wherein the signal line clip voltage setting unit includes
a resistance ladder circuit, and
a first selector that switches a divided voltage generated by the resistance ladder circuit.

19. The imaging device according to claim 18, wherein the signal line reset level generation unit includes
a second selector that switches a divided voltage generated by the resistance ladder circuit.

20. The imaging device according to claim 1, further comprising a pixel array unit in which the pixels are disposed in a matrix in a row direction and a column direction, wherein
the signal line is provided per column, and
the signal line reset transistor and the signal line clip transistor are provided to each signal line.
